(19) United States
(12) Patent Application Publication
(10) Pub. No.: US 2011/0066979 A1
(43) Pub. Date: Mar. 17, 2011

(54) NONDESTRUCTIVE TESTING APPARATUS

(75) Inventor: Koichi MATSUI, Tokyo (JP)

(73) Assignee: OLYMPUS CORPORATION, Tokyo (JP)

(21) Appl. No.: 12/881,355

(22) Filed: Sep. 14, 2010

(30) Foreign Application Priority Data
Sep. 14, 2009 (JP) 2009-212245
Sep. 17, 2009 (JP) 2009-216218

(51) Int. Cl. G06F 3/048

(52) U.S. Cl. 715/823; 715/841; 715/824

(57) ABSTRACT

An endoscope apparatus is a nondestructive testing apparatus and includes: a menu display instruction section for inputting an instruction for displaying a menu screen in a hierarchical structure on a monitor; and a display control section which emphasis-displays a display portion in a hierarchy selected on the menu screen displayed in response to the instruction by the menu display instruction section compared with a display portion in a higher-level hierarchy than the selected hierarchy and a display portion in a lower-level hierarchy than the selected hierarchy, the selected hierarchy being derived from an item in the higher-level hierarchy, and which identifiably displays the item in the higher-level hierarchy, and identifiably displays an already-set item among items in the lower-level hierarchy, when the display portion in the selected hierarchy is emphasis-displayed, the lower-level hierarchy being derived from an item in the selected hierarchy.

### CROSS-REFERENCE TO RELATED APPLICATION

This application claims benefit of Japanese Application No. 2009-212245 filed in Japan on Sep. 14, 2009, and No. 2009-216218 filed in Japan on Sep. 17, 2009, the contents of which are incorporated by this reference.

### BACKGROUND OF THE INVENTION

1. Field of the Invention

The present invention relates to a nondestructive testing apparatus, and more particularly to a nondestructive testing apparatus capable of recording test data such as images.

2. Description of Related Art

Conventionally, endoscope apparatuses as a kind of nondestructive testing apparatuses have been widely used for testing inside of a test object.

For example, a person who performs testing can pick up images of inside a test object such as a plant or an aircraft engine and observe inside the test object, by using an industrial endoscope apparatus. The person who performs testing can record endoscopic images as still images or moving images in a storage apparatus in the endoscope apparatus, for example, a recording medium such as a memory card, during testing. Image data of the recorded endoscopic images are downloaded from the endoscope apparatus to a storage apparatus in a personal computer and the like, and detailed examination is later performed on the data.

Such an endoscope apparatus is provided with various functions. A user can select a desired function by sequentially selecting a corresponding item, from items displayed in hierarchical structure on a monitor, in each of the hierarchies. For example, when the user performs setting as to whether an image is recorded as a still image or both as a still image and a moving image, the user first selects items in the respective hierarchies. When selection of all the items in the respective hierarchies for the setting is completed, a screen for setting as to whether an image is recorded as a still image or a moving image is finally displayed. The user can perform the setting of image recording on the screen.

In addition, Japanese Patent Application Laid-Open Publication No. 2004-121855 discloses a technique for enabling a user to easily understand functions in an endoscope apparatus by displaying the functions using graphics.

During testing, a person who performs testing inserts an insertion portion of the endoscope apparatus inside an object and brings a distal end portion of the insertion portion closer to a region to be observed. Not only the person who performs testing can observe inside the object while viewing an image displayed on a monitor of the endoscope apparatus, i.e., a live image, but also, when the person finds a region to be recorded, for example, the person can record a still image (or still image and moving image) of the region by operating a freeze button with the distal end portion of the insertion portion of the endoscope located at a desired position.

The picked-up still image is once displayed on the monitor. However, after checking the picked-up still image, the person who performs testing can further continue the testing by returning the screen to a live-image displaying state. The person who performs testing can also record the picked-up still image by adding a title thereto. Texts such as the added title and the like are information on the image and the information is used later when the person who performs testing analyzes the image while viewing the image.

For example, Japanese Patent Application Laid-Open Publication No. 2009-142461 discloses an endoscope apparatus to which an external keyboard is connectable for inputting characters.

### SUMMARY OF THE INVENTION

According to one aspect of the present invention, it is possible to provide a nondestructive testing apparatus including: a menu display instruction section for inputting an instruction for displaying a menu screen in a hierarchical structure on a monitor; and a display control section which emphasis-displays a display portion in a hierarchy selected on the menu screen displayed in response to the instruction by the menu display instruction section compared with a display portion in a higher-level hierarchy than the selected hierarchy and a display portion in a lower-level hierarchy than the selected hierarchy, the selected hierarchy being derived from an item in the higher-level hierarchy, and which identifiably displays the item in the higher-level hierarchy, and identifiably displays an already-set item among items in the lower-level hierarchy, when the display portion in the selected hierarchy is emphasis-displayed, the lower-level hierarchy being derived from an item in the selected hierarchy.

### BRIEF DESCRIPTION OF THE DRAWINGS

FIG. 1 is a configuration view illustrating an appearance of an endoscope apparatus according to an embodiment of the present invention.

FIG. 2 is a perspective view illustrating each component of an operation portion 5 according to the embodiment of the present invention.

FIG. 3 is a block diagram of an endoscope apparatus 1 for illustrating a hardware configuration of a main body unit 2 according to the embodiment of the present invention.

FIG. 4 is a flowchart showing an example of a flow of processing steps to be performed when a freeze button 5k is depressed, according to the embodiment of the present invention.

FIG. 5 is a flowchart showing an example of the flow of processing steps to be performed when the freeze button 5k is depressed, according to the embodiment of the present invention.

FIG. 6 is a view for illustrating an example of transition of screen displayed on an LCD 4, according to the embodiment of the present invention.

FIG. 7 is a view for illustrating an example of transition of screen displayed on the LCD 4, according to the embodiment of the present invention.

FIG. 8 is a view showing a configuration of a menu screen G2 according to the embodiment of the present invention.

FIG. 9 is a flowchart showing a content of a processing in step S4 according to the embodiment of the present invention.

FIG. 10 is a view showing a menu screen G2b1 which is in a title input enable state, according to the embodiment of the present invention.

FIG. 11 is a view showing an example of character input according to the embodiment of the present invention.

FIG. 12 is a view for illustrating one example of another title input method according to the embodiment of the present invention.

FIG. 13 is a view for illustrating the one example of the other title input method according to the embodiment of the present invention.

FIG. 14 is a view for illustrating the one example of the other title input method according to the embodiment of the present invention.

FIG. 15 is a view for illustrating the other example of the other title input method according to the embodiment of the present invention.

FIG. 16 is a view for illustrating the other example of the other title input method according to the embodiment of the present invention.

FIG. 17 is a view showing an example of a retrieve screen according to the embodiment of the present invention.

FIG. 18 is a view showing a configuration of a menu screen G12 of the retrieve screen according to the embodiment of the present invention.

FIG. 19 is a view showing the menu screen G12 on which an icon 111b2 is in a selectable state according to the embodiment of the present invention.

FIG. 20 is a view showing a screen G12b3 for creating a new folder according to the embodiment of the present invention.

FIG. 21 is a view showing that an icon 101b2 is in a selectable state according to the embodiment of the present invention.

FIG. 22 is a view showing a menu screen G2b2 indicating a white balance executable state according to the embodiment of the present invention.

FIG. 23 is a view showing that an icon 101b3 is in a selectable state according to the embodiment of the present invention.

FIG. 24 is a view showing a menu screen G2b3 displayed when a recording operation is selected according to the embodiment of the present invention.

FIG. 25 is a view showing a menu screen G2ba displayed when a recording button operation is selected according to the embodiment of the present invention.

FIG. 26 is a view showing that an icon 101b4 is in a selectable state according to the embodiment of the present invention.

FIG. 27 is a view showing a menu screen G2b4 indicating a date and time setting executable state according to the embodiment of the present invention.

FIG. 28 is a view showing the menu screen G2b4 indicating the date and time setting executable state according to the embodiment of the present invention.

FIG. 29 is a view showing the menu screen G2b4 indicating the date and time setting executable state according to the embodiment of the present invention.

FIG. 30 is a view showing the state where an icon 101b5 is in a selectable state according to the embodiment of the present invention.

FIG. 31 is a view showing a menu screen G2b5 displayed when a setup operation is selected according to the embodiment of the present invention.

FIG. 32 is a view showing a menu screen G2b51 displayed when a formatting operation is selected according to the embodiment of the present invention.

FIG. 33 is a view showing the menu screen G2b5 displayed when the setup operation is selected according to the embodiment of the present invention.

FIG. 34 is a view showing a menu screen G2b52 displayed when a screen display operation is selected according to the embodiment of the present invention.

FIG. 35 is a view showing a menu screen G2b5 displayed when the setup operation is selected according to the embodiment of the present invention.

FIG. 36 is a view showing a menu screen G2b53 displayed when a beep sound setting operation is selected according to the embodiment of the present invention.

FIG. 37 is a view showing that an icon 101b6 is in a selectable state according to the embodiment of the present invention.

FIG. 38 is a view showing a menu screen G12b5 displayed when an icon 111b5 is selected according to the embodiment of the present invention.

FIG. 39 is a view showing a transition of the screen on the LCD 4 of the endoscope apparatus 1, according to the embodiment of the present invention.

### DETAILED DESCRIPTION OF PREFERRED EMBODIMENTS

Hereinafter, an embodiment of the present invention will be described with reference to the drawings.

### 1. Overall Configuration

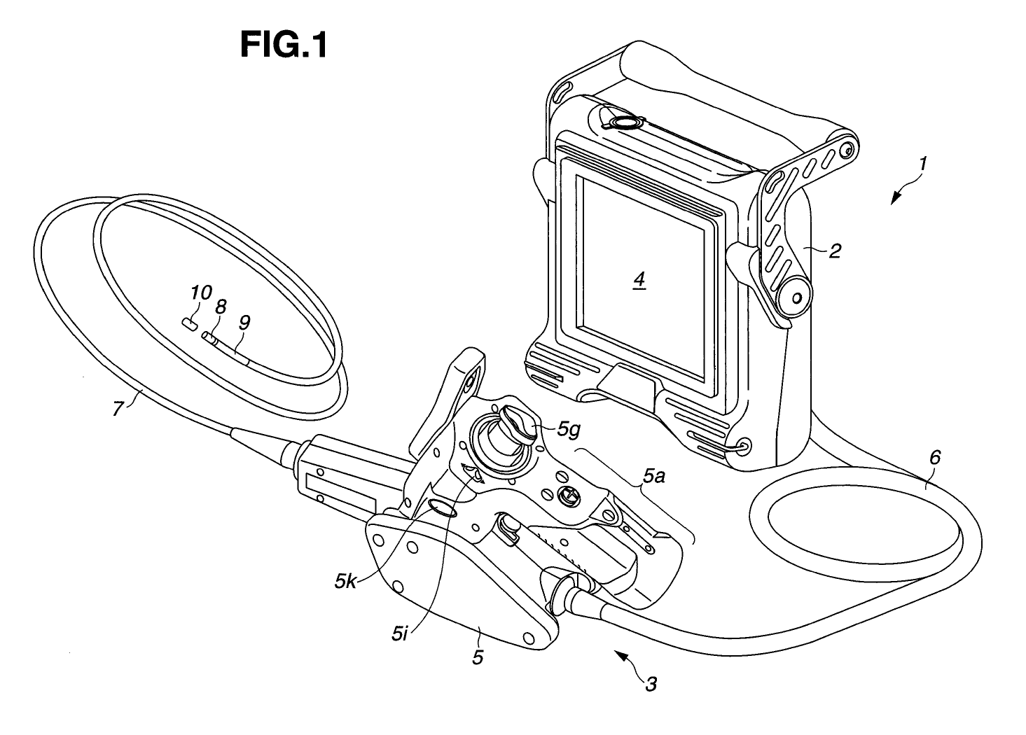

First, a configuration of an endoscope apparatus according to the present embodiment will be described with reference to FIG. 1. FIG. 1 is a configuration view illustrating an appearance of the endoscope apparatus according to the present embodiment.

An endoscope apparatus 1 is a kind of nondestructive testing apparatus, and is a testing apparatus which is capable of observing and testing inside a test object without taking the test object to pieces.

In FIG. 1, the endoscope apparatus 1 is configured by including a main body unit 2 as a main unit and a scope unit 3 connected to the main body unit 2. The main body unit 2 includes a liquid crystal panel (hereinafter abbreviated as LCD) 4 as a display device on which an endoscopic image, an operation menu, and the like are displayed. The scope unit 3 includes an operation portion 5 and connected with the main body unit 2 via a universal cable 6 as a connection cable. The scope unit 3 also includes an insertion portion 7 made of a flexible insertion tube. The insertion portion 7 incorporates, at a distal end portion 8 thereof, an image pickup device such as a CCD, not shown. An image pickup optical system such as a lens is arranged on an image pickup surface side of the image pickup device. A bending portion 9 is provided on a proximal end side of the distal end portion 8. An optical adapter 10 is attachable to the distal end portion 8.

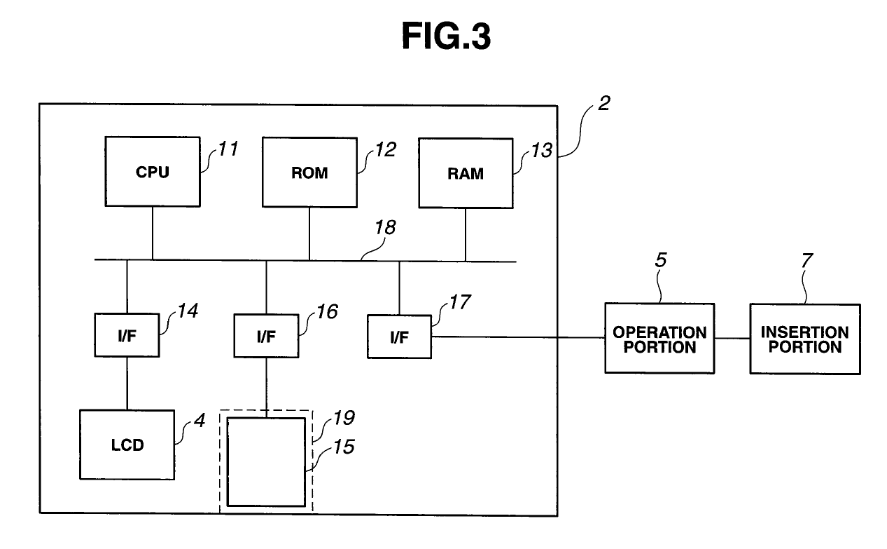

Image data obtained by picking up an image of a test object is a test data of the test object. The image data is recorded in a storage medium 15 such as a memory card. The storage medium 15 is attachable to and detachable from a slot 19 provided to the main body unit 2 (See FIG. 3).

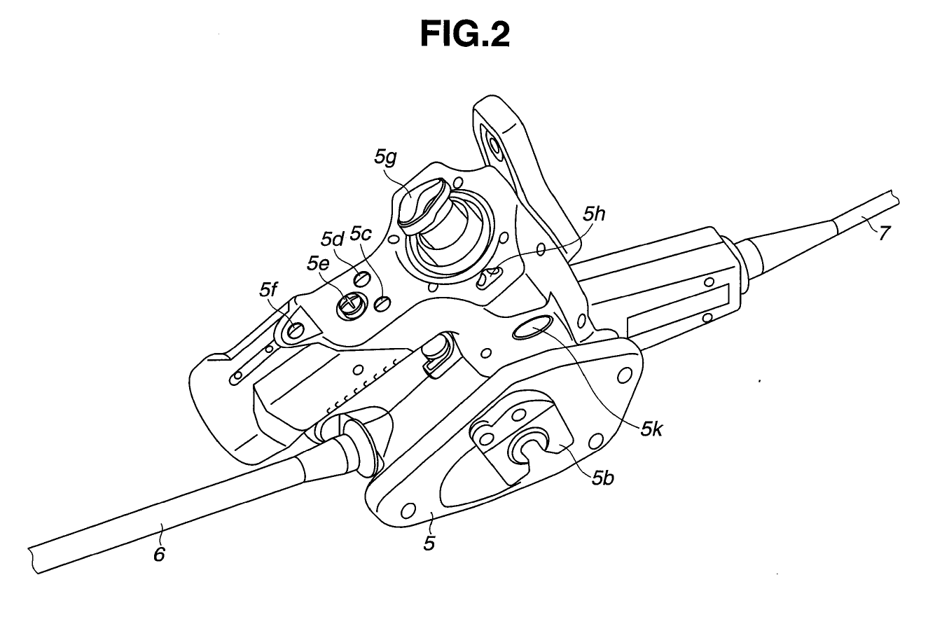

FIG. 2 is a perspective view for illustrating each component of the operation portion 5. Description will be made on each component of the operation portion 5 with reference to FIGS. 1 and 2.

The operation portion 5 has a grip portion 5a. A user as a person who performs testing can hold the operation portion 5 by grasping the grip portion 5a with his or her hand. In addition, a hanger Sb for fixing the operation portion 5 to the main body unit 2 is provided on one side surface of the operation portion 5. The user hangs the operation portion 5 on the main body unit 2 by engaging the hanger Sb with a hook portion, not shown, of the main body unit 2.

The grip portion 5a includes a live screen display button 5c for displaying a live endoscopic image, a menu display button 5d for displaying a menu screen, a joystick Se for selecting a menu, and a view button 5f for displaying a retrieve screen on which recorded images are displayed as thumbnail images.

The function of the joystick Se is not limited to move a cursor on the screen of the LCD 4 as a monitor. When the joystick Se is depressed, the joystick Se also functions as a decision button for instructing a decision of the selected state.

A joystick 5g for bending operation of the bending portion 9 is disposed on a proximal end portion of the grip portion 5a. A zoom lever 5h for zooming in an image is disposed on the right side of the joystick 5g, when viewed from the user. A luminance lever 5i for adjusting brightness of an observation image is disposed on the left side of the joystick 5g, when viewed from the user. Furthermore, two freeze buttons 5k for freezing or recording the observation image are disposed such that each of the freeze buttons is located on the left side and the right side of the joystick 5g at positions more distant from the joystick 5g than the positions of the luminance lever 5i and the zoom lever 5h. The user can observe inside the test object and record images of the test object by operating such buttons while grasping the grip 5a of the operation portion 5.

### 2. Circuit Configuration

FIG. 3 is a block diagram of the endoscope apparatus 1 for illustrating a hardware configuration of the main body unit 2. The main body unit 2 includes a CPU 11, a ROM 12, a RAM 13, an interface section (hereinafter abbreviated as I/F) 14 with the LCD 4, an I/F 16 with the storage medium 15, and an I/F 17 with the operation portion 5, and these components are connected to one another via a bus 18. The storage medium 15 is detachably attached to the slot 19 provided to the main body unit 2.

The I/F 17 receives an operation signal from the operation portion 15. The main body unit 2 receives an operation signal from the operation portion 5.

The ROM 12 stores a software program (hereinafter just referred to as program) for carrying out various functions of the endoscope apparatus 1, and the CPU 11 executes the program. The CPU 11 is configured to operate so as to carry out the various functions depending on operation signal received from the operation portion 5.

When the menu display button 5d and the like provided on the operation portion 5 is operated, a signal corresponding to the operation is inputted to the CPU 11 via the I/F 17 and the inputted signal is detected. The CPU 11 executes various operation controls, display control, and the like, based on the detected signal.

For example, as described later, when the menu display button 5d is operated, the CPU 11 executes a processing such as displaying of a menu screen on the LCD 4 which is a monitor, depending on the display state, the setting state, and the like at the time.

FIG. 3 omits illustration of components related to the communication with the power source and external apparatuses other than the screen display control of the LCD to be described in the present embodiment.

When the user as the person who performs testing tests a turbine blade in an aircraft engine as a test object using the endoscope apparatus 1, for example, the user operates the insertion portion 7 by hand to insert the insertion portion 7 into the engine, and performs testing inside the engine while viewing the endoscopic image displayed on the LCD 4.

The endoscope apparatus 1 includes various functions, and a live endoscopic image (hereinafter shortly referred to as live image) is normally displayed on the LCD 4. When the person who performs testing desires to obtain a still image of the live endoscopic image, he or she depresses the freeze button 5k. The button operation enables the still image to be recorded in the storage medium 15.

Next, display processing of the endoscope apparatus 1 will be described. First, description will be made on title input processing according to the present embodiment.

### 3. Processing Related to Menu Screen Display and Title Input Screen Display

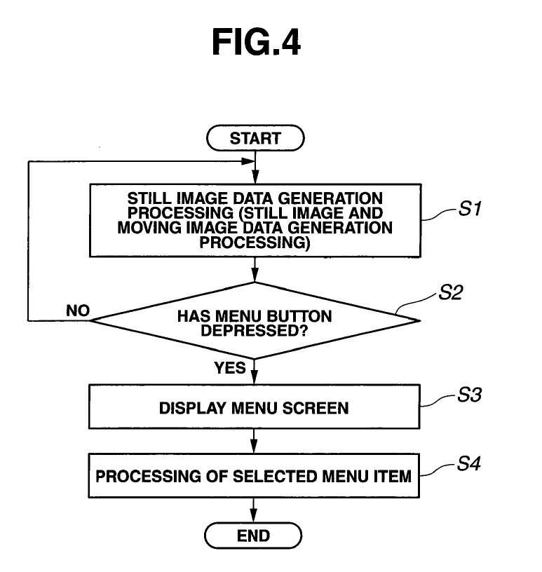

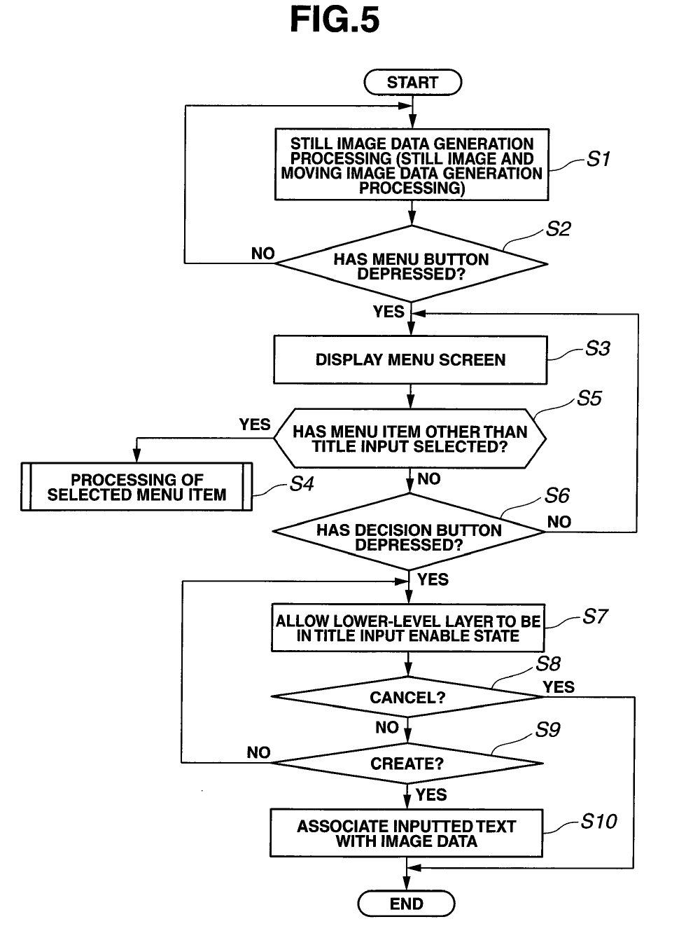

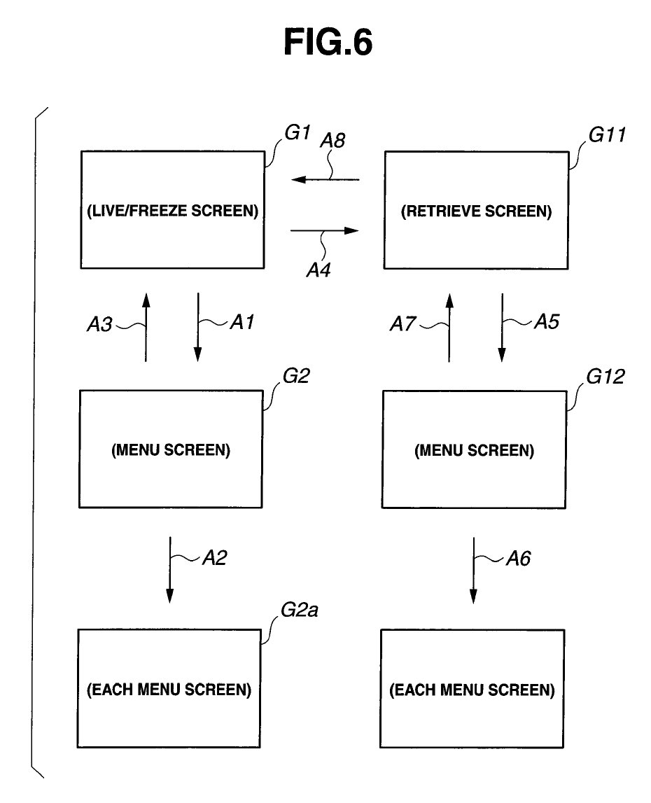

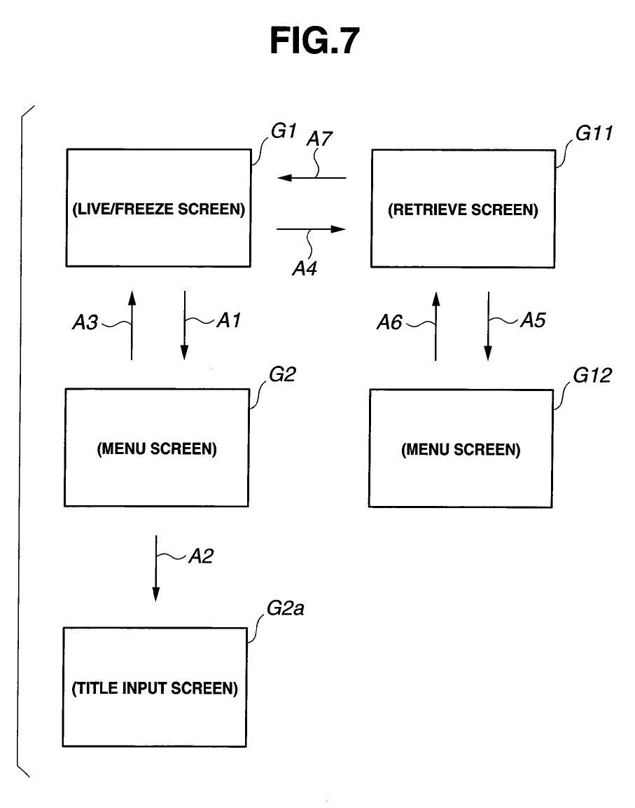

It is supposed that the person who performs testing depresses the freeze button 5k when he or she is viewing a live endoscopic image. FIG. 4 is a flowchart showing an example of a flow of processing steps to be performed when the freeze button 5k is depressed. FIG. 5 is a flowchart specifically showing an example of a flow of title input processing steps to be performed when the freeze button 5k is depressed. FIG. 6 is a view illustrating an example of transition of the screen displayed on the LCD 4. FIG. 7 is a view specifically illustrating an example of transition of the screen related to title input which is displayed on the LCD 4. Description will be made with reference to FIGS. 4, 5 and FIGS. 6, 7. The processing steps shown in FIGS. 4 and 5 are performed by the CPU 11 reading out the program stored in the ROM 12 and executing the read out program. FIG. 4 shows a part of the processing steps performed by the program, that is, mainly the display processing of the menu screen.

When the freeze button 5k is depressed, the CPU 11 executes a still image data generating processing for generating a still image from a video signal received from the image pickup device provided at the distal end portion 8 of the insertion portion 7 (step S1). As a result, the obtained still image is displayed on the LCD 4 as a live/freeze screen G1. The live/freeze screen G1 normally displays a live image, but when the freeze button 5k is depressed, the live/freeze screen G1 displays the still image. Return operation from the still image to the live image is performed by depressing the live screen display button 5c or the menu display button 5d. Depending on a setting regarding a recording mode in the endoscope apparatus 1, the endoscope apparatus 1 is set in a mode for recording both still image and moving image by depression of the freeze button. In that case, in the step S1, a processing for generating both still image data and moving image data is performed. In this state, the still image based on the generated still image data is displayed on the LCD 4. The still image data at this time is temporarily stored in the RAM 13.

Next, determination is made on whether or not the user has depressed the menu display button 5d (step S2). When the menu display button 5d is depressed, that is, an instruction for displaying the menu screen is given, it is determined as YES in the step S2, and as shown by the arrow A1 in FIG. 6, the CPU 11 changes the screen from the live/freeze screen G1 to a menu screen G2 and displays the menu screen G2 (step S3).

The step S2 constitutes a menu display instruction section for inputting an instruction for displaying a menu screen in a hierarchical structure on the LCD 4.

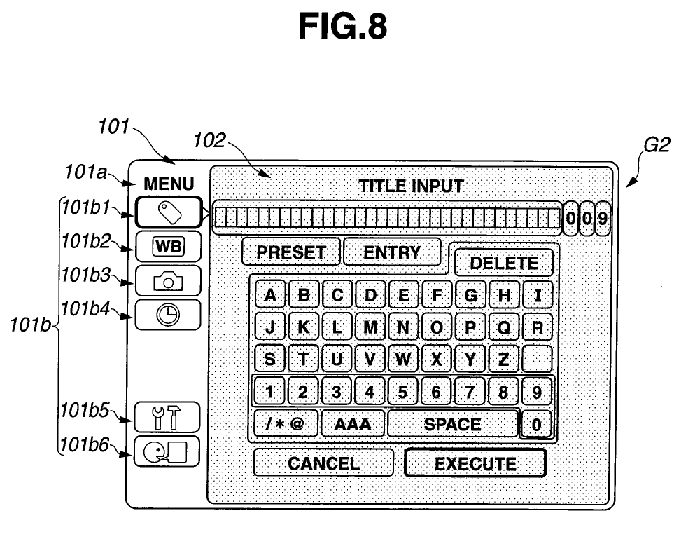

FIG. 8 is a view showing a configuration of the menu screen G2. The menu screen G2 is a graphical user interface (GUI) displayed when the menu display button 5d is depressed, in other words, the instruction for displaying the menu screen is given.

As shown in FIG. 8, the menu screen G2 includes a menu item display portion 101 as a higher-level layer display portion which is the highest-level layer screen and includes a plurality of menu items, and a lower-level layer display portion 102 for displaying a lower-level layer screen corresponding to the menu item in the selectable state. As described later, in FIG. 8, the icon is the selectable state is an icon 101b1, so that the contents corresponding to the icon 101b1 are displayed on the lower-level layer display portion 102. As shown in FIG. 8, on the menu screen G2, the lower-level layer display portion 102 is so displayed as to cover a part of the higher-level layer display portion 101. At this time, the lower-level layer display portion 102 which is a display portion in the lower-level hierarchy is displayed superposed on the higher-level layer display portion 101 such that the items, that is, icons 101b1 to 101b6 on the higher-level layer display portion 101 which is a display portion in the higher-level hierarchy can be visually identified.

Note that, as shown in FIG. 8, the display portions in the respective hierarchies are displayed as rectangular windows in such a manner as to be superposed on each other from the left to the right direction of the display screen of the monitor when facing the monitor.

The menu item display portion 101 includes a display area where characters “MENU” 101a indicative of the highest-level layer screen and a plurality of icons 101b corresponding to a plurality of selectable menu items are displayed. The plurality of icons 101b include six icons arranged so as to align in the vertical direction on the screen.

The uppermost icon 101b1 is an icon for displaying a title input screen. Similarly, an icon 101b2 below the icon 101b1 is an icon for displaying a screen related to execution of white balance. An icon 101b3 below the icon 101b2 is an icon for displaying a screen related to a setting of recording mode.

In addition, below the icon 101b3, an icon 101b4 for displaying a date and time setting screen, an icon 101b5 for displaying a setup screen, and an icon 106b for displaying a language setting screen.

The three icons 101b1 to 101b3 are icons related to the functions which are relatively frequently used by the user. The three icons 101b4 to 101b6 are icons related to the functions which is relatively less frequently used by the user than those of the above three icons.

With reference to FIG. 4 again, on the menu screen G2 displayed when the menu display button 5d is depressed in step S2, among the menu items, the item of the title input screen is displayed in a selectable state. That is, as shown in FIG. 8, the frame of the icon 101b is displayed in bold so that the icon 101b1 for displaying the title input screen can be distinguished from other icons 101b2 to 101b6, that is, the icon 101b1 is identifiable, thereby indicating that the icon 101b is in the selectable state. The selectable state of the icon means the state where the function of the icon can be executed only by receiving execution instruction. Furthermore, the title input screen corresponding to the icon 101b1 in the selectable state is displayed grayed out on the lower-level layer display portion 102. The grayed-out display means an achromatic low-luminance display by changing the color and decreasing the luminance, such as the display only with pale white and black colors, for example.

If already-inputted texts related to image data exist on the title input screen as the text input screen, the title input screen is displayed in the selectable state with the already-inputted texts being displayed.

In other words, immediately after the procedure of the processing transited from the step S2 to step S3 and the menu screen G2 was displayed, the menu item display portion 101 on the menu screen G2 notifies the user that a plurality of menu items are selectable while indicating that the title input screen is in the selectable state, and the grayed-out lower-level layer display portion 102 displays the contents of the title input screen in a visually identifiable manner for the user.

The step S3 constitutes a text input screen display section which allows a text input screen for inputting text data related to image data as test data to be displayed in the selectable state on the screen of the LCD 4.

In this embodiment, the frame of the icon in the selectable state is displayed in bold. However, the icon in the selectable state may be displayed highlighted by changing color, for example, so as to be distinguishable from other icons.

When one item is selected from the six menu items by a user in the screen state shown in FIG. 8, the processing moves on to the processing of the selected menu item as shown by the arrow A2 in FIG. 6 (step S4). The processings in step S3 and S4 constitute a display control section.

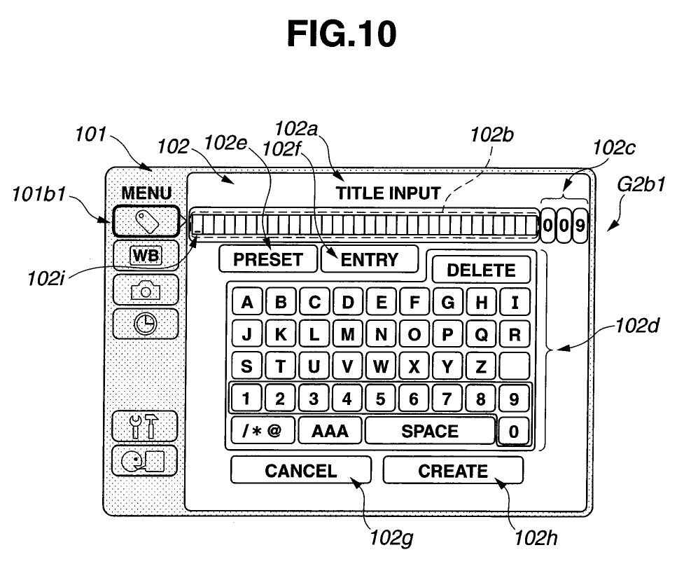

When the user depresses the decision button, that is, depresses the joystick 5e or tilts the joystick rightward in the screen state shown in FIG. 8, for example, the menu item for title input is selected, and the CPU 11 allows the lower-level layer display portion 102 on the title input screen G2 to be in a title input enable state. As a result, the screen of the LCD 4 is changed to a menu screen G2b1 (FIG. 10) which is in the title input enable state.

The depression of the joystick 5e constitutes a decision instruction section for instructing the selection decision of the selectable item in the display of the menu.

Note that the processing in the step S4 in FIG. 4 is executed also when the retrieve menu screen to be described later is displayed.

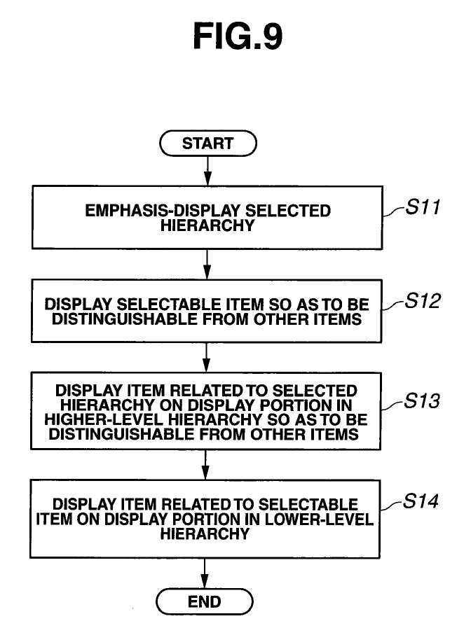

FIG. 9 is a flowchart showing the content of the processing in the step S4. First, the contents of the processing steps in FIG. 9 are described briefly, and the specific content of each of the processing steps in FIG. 9 will be described later with reference to screen display examples.

First, the CPU 11 emphasis-displays the display portion in the hierarchy (i.e., active hierarchy) selected on the menu screen G2 (step S11).

Next, the CPU 11 displays the item in the selectable state so as to be identifiable, that is, distinguishable from other items in the selected hierarchy (step S12).

Then, the CPU 11 displays, in the display portion in the higher-level hierarchy, the item related to the selected hierarchy so as to be identifiable, that is, distinguishable from other items (step S13).

Furthermore, the CPU 11 displays the items related to the selectable item in the display portion in the lower-level hierarchy (step S14). In the step S14, if there is an item which has been already selected or set in the lower-level hierarchy, also the processing for displaying the already-selected or already-set item so as to be identifiable, that is, distinguishable from other items is performed.

That is, in the step S4 constituting the display control section, the following processing is performed. The display portion in the hierarchy selected on the menu screen displayed in response to the instruction is emphasis-displayed compared with the display portion in the higher-level hierarchy than the selected hierarchy and the display portion in the lower-level hierarchy than the selected hierarchy. When the display portion in the selected hierarchy is emphasis-displayed, the item in the higher-level hierarchy which is related to the selected hierarchy is identifiably displayed (that is, the selected hierarchy is derived from the item in the higher-level hierarchy), and among the items in the lower-level hierarchy related to (derived from) the item in the selected hierarchy, the already-set item is identifiably displayed.

In addition, when the selected hierarchy and the lower-level hierarchy related thereto are displayed, the display portion in the selected hierarchy is displayed superposed on the display portion in the higher-level hierarchy such that the items in the higher-level hierarchy can be visually identified, and the display portion in the lower-level hierarchy is displayed superposed on the display portion in the selected hierarchy such that the item in the selected hierarchy can be visually identified.

The step S12 is not executed when a selectable item is not set or selected. Similarly, the step S13 is not executed when no higher-level hierarchy relative to the selected hierarchy exists. The step S14 is not executed when no lower-level hierarchy relative to the selected hierarchy exists.

Furthermore, the order of the four processing steps from the step S11 to step S14 is not limited to the order shown in FIG. 9.

Restoration to the menu screen G12 from each menu screen can be performed by depression of the menu display button 5c or leftward tilting of the joystick 5e.

Furthermore, the screen is changed to the menu screen G2b1 in the title input enable state also by rightward tilting operation of the joystick 5e in the state shown in FIG. 8 (that is, performing the operation which means the movement to the lower-level layer on the right side of the higher-level layer on the screen in FIG. 8).

In addition, when the menu display button 5d or the live screen display button 5c is depressed in the state where the menu screen G2 is displayed as shown in FIG. 8, the screen returns to the live/freeze screen G1 as shown by the arrow A3 in FIG. 6.

Therefore, the user can select a desired hierarchy in the hierarchical structure by depressing the decision button or tilting the joystick 5e, to allow the desired hierarchy to be in an active state. For example, on the menu screen, the user can change the state of screen from the state where the menu item display portion 101 is active as shown in FIG. 8 to the state where the lower-level layer display portion 102 is active as shown in FIG. 10.

Restoration to the live/freeze screen G1 from each menu screen can be performed by selecting setting or execution of item function in the lower-level layer display portion, or depressing live screen display button 5c.

Now, with reference to FIG. 5, detailed description will be made on the case where the title input was selected in the step S4 in FIG. 4.

Determination is made on whether or not the menu item other than the title input has been selected in the state shown in FIG. 8 (step S5). When it is determined that the menu item other than the title input has been selected, the processing step moves on to the processing of the selected menu item (step S4).

When it is determined that the menu item other than the title input is not selected, determination is made whether or not the user has depressed the decision button, i.e., the joystick 5e (step S6). The depression of the joystick 5e which also serves as the decision button means selection of the icon in the selectable state. Accordingly, when the joystick 5e has been depressed, the CPU 11 allows the lower-level layer display portion 102 on the title input screen G2 to be in the title input enable state (step S7). That is, as shown by the arrow A2 in FIG. 7, the CPU 11 changes the screen of the LCD 4 to the menu screen G2b1 (FIG. 10) in the title input enable state and displays the menu screen G2b1.

The depression of the joystick 5e in step S6 constitutes the decision instruction section for instructing the selection decision of the selectable item in the display of the menu. Step S7 constitutes a text input state change section which changes the state of the text input screen to allow text data to be inputtable in a title input field in the text input screen, when the instruction for selection decision in step S6 is given by the decision instruction section in the state where the title input screen as the text input screen is displayed in the selectable state.

If the joystick 5e as the decision button is not depressed, it is determined as NO in the step S6, the processing step returns to the step S3, and the screen remains as the title input screen G2. Furthermore, the screen is changed to the menu screen G2b1 in the title input enable state also by rightward tilting operation of the joystick 5e in the state shown in FIG. 8 (that is, performing the operation which means movement to the lower-level layer on the right side of the higher-level layer on the screen shown in FIG. 8).

In addition, when the menu display button 5d or the live screen display button 5c is depressed in the display state of the menu screen G2 shown in FIG. 8, the screen returns to the live/freeze screen G1 as shown by the arrow A3 in FIG. 7.

FIG. 10 is a view showing a menu screen G2b1 which is in the title input enable state. As shown in FIG. 10, when the menu screen is in the title input enable state, the higher-level layer display portion 101 is grayed out, and the lower-level layer display portion 102 is emphasis-displayed and becomes bright. This is because the lower-level layer display portion 102 is displayed in a more emphasized manner compared with the higher-level layer display portion 101 by the processing in the step S11 in FIG. 9. In addition, since the lower-level layer display portion 102 relates to the item indicated by the icon 101b1 on the higher-level layer display portion 101, the icon 101b1 is displayed with a bold frame such that the icon 101b1 can be distinguished from other icons such as 101b2 by the processing in the step S13 in FIG. 9.

The title input screen on the lower-level layer display portion 102 includes: characters “title input” 102a which indicates that the lower-level layer relates to the title input; a title input field 102b shown by dotted lines; a sequential number setting portion 102c, a software keyboard display portion 102d, a preset button 102e, an entry button 102f, a cancel button 102g, and a create button 102h.

When the screen changed from the screen shown in FIG. 8 to the screen shown in FIG. 10, a cursor 102i indicative of a character input position is displayed so as to be positioned at the head position (left end position in FIG. 10) in the title input field 102b. If already-inputted text data exists, the cursor 102i is displayed at the position next to (right side of) the last letter of the already-inputted text.

In the state of the menu screen G2a shown in FIG. 10, the user can input characters in the title input field 102b using the software keyboard 102d.

The user can switch the screen to Japanese syllabary input enable screen by switching between symbol input and Japanese syllabary input, not shown.

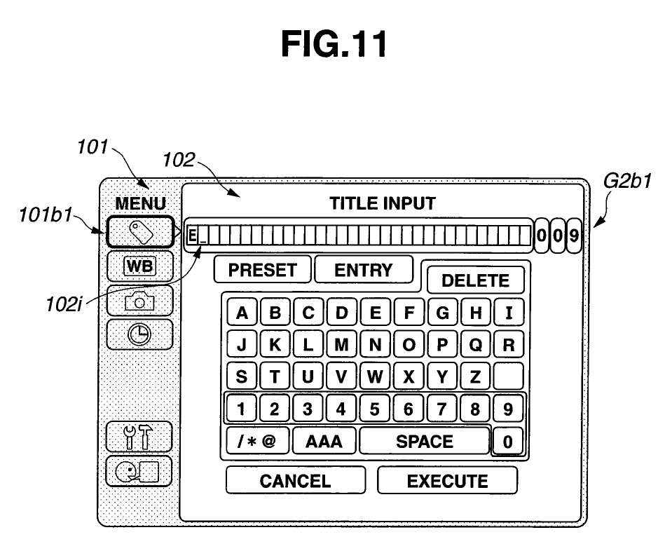

FIG. 11 shows an example of character input. The user sequentially selects the character which he or she desires to input while moving the cursor (not shown) on the screen by operating the joystick 5e of the operation portion 5, thereby capable of inputting a title composed of the selected characters in the title input field 102b. FIG. 11 shows the state where the character “E” is selected and inputted in the title input field 102b. In FIG. 11, selection of the character “E” is shown by the frame of the character “E” displayed in bold. In addition, FIG. 11 also shows that the character “E” is inputted in the character input field 102b.

The number set in the sequential number setting portion 102c is added to the inputted title. The sequential number setting portion 102c is a portion in which a plurality of digits of number, three-digit number in the present embodiment, is displayed. The user can increment and decrement the number by performing a predetermined operation.

### (Another Title-Input Method)

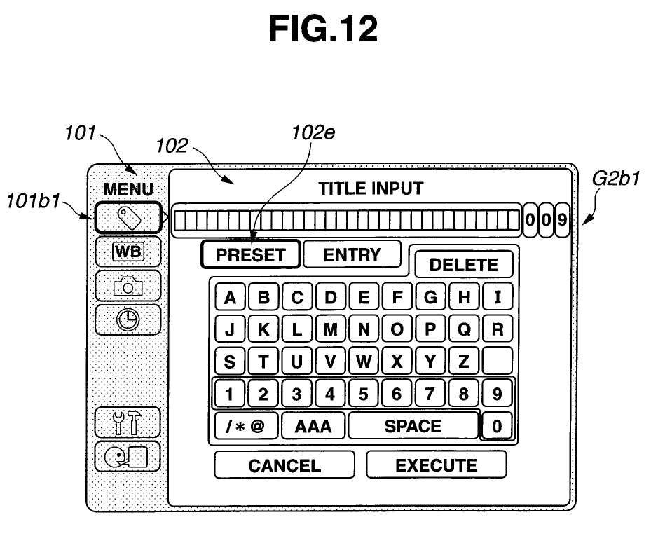

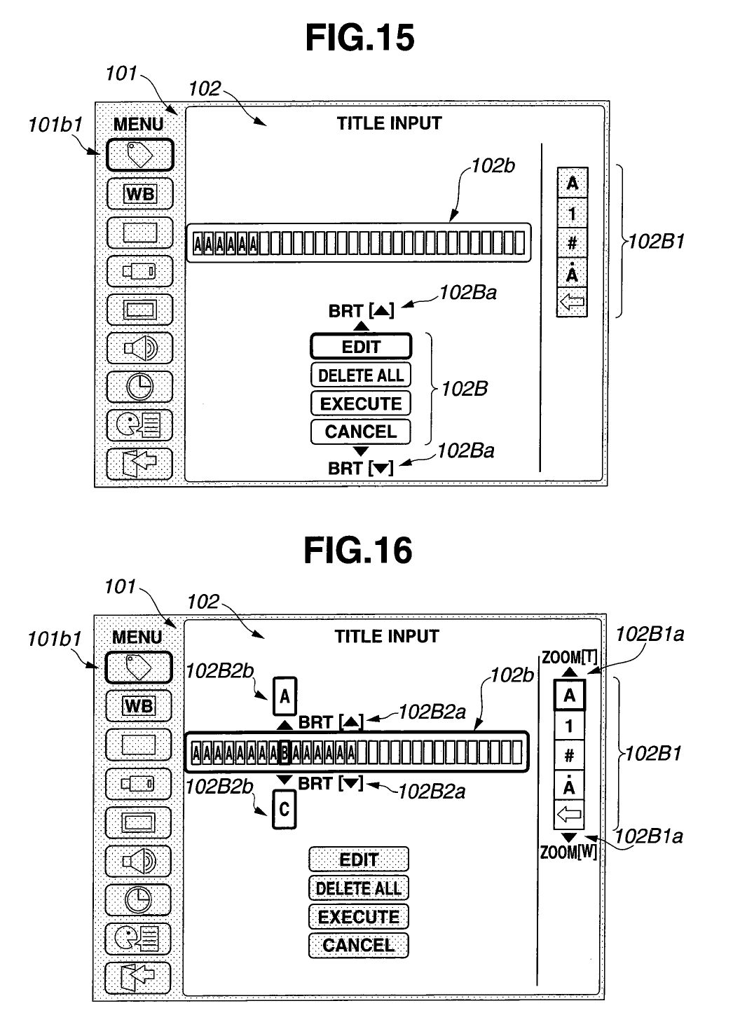

Furthermore, the user can input characters by using another title-input method. FIGS. 12 to 16 are views for illustrating the other title-input method. FIGS. 12 to 14 are views for illustrating one example of the other title-input method. FIGS. 15 and 16 are views for illustrating another example of the other title-input method.

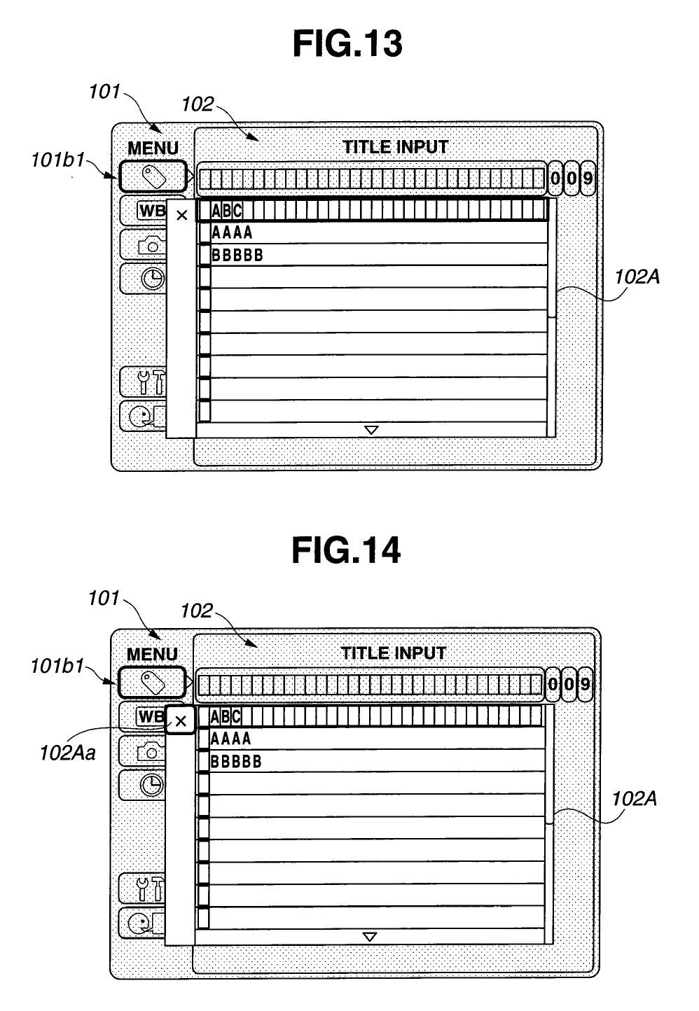

As a first method, characters can be inputted by selecting a previously registered text as shown in FIGS. 12 and 13. When the preset button (“PRESET”) 102e is selected on the menu screen G2b1 as shown in FIG. 12, a pop-up window 102A is displayed as shown in FIG. 13. In the pop-up window 102A, a plurality of preset texts are displayed in a list form. In FIG. 13, the text “ABC” is displayed at the uppermost position in the pop-up window 102A. When the text is selected, the text is inputted in the title input field 102b. That is, it is possible to efficiently input the title by preparing and registering fixed texts in advance. Correction, addition, and the like can be performed on the selected and inputted text with the text inputted in the title input field 102b. When the user desires to remove the pop-up window 102A from the screen, if the user selects the cross mark “x” 102Aa for closing the window, as shown in FIG. 14, the screen of the LCD 4 returns from the state shown in FIG. 13 to the state shown in FIG. 11.

Furthermore, as a second method, also the title input method as shown in FIGS. 15 and 16 can be used. By performing a predetermined operation, the title input screen as shown in FIG. 15 is displayed on the LCD 4.

In FIG. 15, a command display portion 102B is displayed together with the title input field 102b. The command display portion 102B includes buttons such as “EDIT” for editing, “DELETE ALL” for deleting all, “EXECUTE” for instructing execution of processing, and “CANCEL” for cancel of the processing. In FIG. 15, “EDIT” button is displayed with a bold frame in a selectable state, and on the right side of the screen, an input character setting portion 102B1 for selecting characters to be inputted such as letters and numerical symbols is displayed grayed out.

Selection of a command from the commands displayed in the command display portion 102B can be made by moving the cursor displayed with bold frame. The bold frame can be moved by upward or downward tilting operation of a luminance lever 5i. The user is notified by triangular arrows 102Ba displayed above and below the “BRT” in FIG. 15 that the bold frame can be moved using the luminance lever 5i.

In FIG. 15, the “EDIT” is in a selectable state. When the “EDIT” command is executed by depressing the joystick 5e, the screen as shown in FIG. 16 is displayed on the LCD 4. In FIG. 16, an alphabet input enable state is selected on the input character setting portion 102B1. When inputting another kind of characters, the user can change the kind of characters to be inputted by moving the cursor displayed with bold frame on the input character setting portion 102B1. The user is notified by arrow symbols 102B1a displayed above and below “ZOOM” in FIG. 16 that the bold frame can be moved using the zoom lever 5h.

As shown in FIG. 16, the user can input a desired character at a position where the cursor is located in the title input field 102b by selecting alphabetic characters to be inputted. The user can select the alphabetic characters to be inputted by upward or downward tilting operation of the luminance lever 5i. The user is notified by triangular arrows 102Ba displayed above and below the “BRT” in FIG. 16 that the alphabetic characters can be selected by the upward and downward tilting operation of the luminance lever 5i. Furthermore, character display portions 102B2b are provided above and below the arrow mark 102B2a. The character display portions 102B2b shows the previous and the next character of the inputted character when the inputted character is set so as to be sequentially changed.

Even if the user inputs a title to be added to a still image obtained by freezing the screen using the input method as shown in FIG. 10 and the like in the step S7 in FIG. 5, when the cancel button 102g is selected, it is determined as YES in the step S8. As a result, no processing is performed and the screen returns to the display of the live/freeze screen G1. “No processing is performed” means that processing of discarding the editing contents of the inputted title is performed. In addition, when the create button 102h is selected, it is determined as YES in step S9 and the CPU 11 associates the inputted text data with the still image data (step S10). After that, the screen returns to the display of the live/freeze screen G1.

In addition, when the title input screen is displayed in the step S7 and neither the cancel button 102g nor the create button 102h is selected, it is determined as NO in the steps S8 and S9, the processing remains as-is in the step S7.

Note that also when the menu display button 5d or the live screen display button 5c is depressed in the display states shown in FIGS. 10, 13 and the like, the display of the LCD 4 returns to the display of the live/freeze screen G1.

After the desired title is added to the still image (or both still image and moving image) obtained by depressing the freeze button 5k, the screen returns to the live screen of the live/freeze screen G1. Accordingly, the user can continue the testing by using the endoscope apparatus 1.

Subsequently, after obtaining a still image by depressing the freeze button 5k again, the user can add the title to the obtained still image data only by performing the above-described operation, more specifically, by depressing the menu display button 5d and then depressing the joystick 5e. After the completion of the input of the desired title, the live screen is displayed again, that is, the screen returns to the state where the user can continue the testing.

Accordingly, every time the user obtains a still image, the user can switch the screen to the title input screen with a simple operation, more specifically, the depression operations of the menu display button 5d and the joystick 5e as the decision button. Therefore, the user can efficiently perform the testing.

One of the reasons why the depression operation of the joystick 5e as the decision button is required is to cause the user to check the operation contents. Another reason is that the relatively frequently used menu items are the other menu items other than the title input.

Note that the characters of the title may be inputted with another title input method other than the methods described in FIGS. 10 to 16.

### 4. Retrieve Screen

The person who performs testing can record the still images and the like of the test object in the storage medium 15 by using the endoscope apparatus 1. The person who performs testing also enables the recorded still images and the like to be displayed on the LCD 4. However, in some cases, the person who performs testing desires to combine the recorded still images and the like into one folder in the endoscope apparatus 1. Furthermore, in other cases, the person who performs testing desires to copy or delete the data of the already-recorded still images or moving images, for example.

In such cases, in the endoscope apparatus 1, the person who performs testing can switch from the live/freeze screen G1 to a retrieve screen G11 as shown by the arrow A4 in FIG. 6 by depressing the view button 5f of the operation portion 5, i.e., by pressing the view button 5f for a long time in the present embodiment.

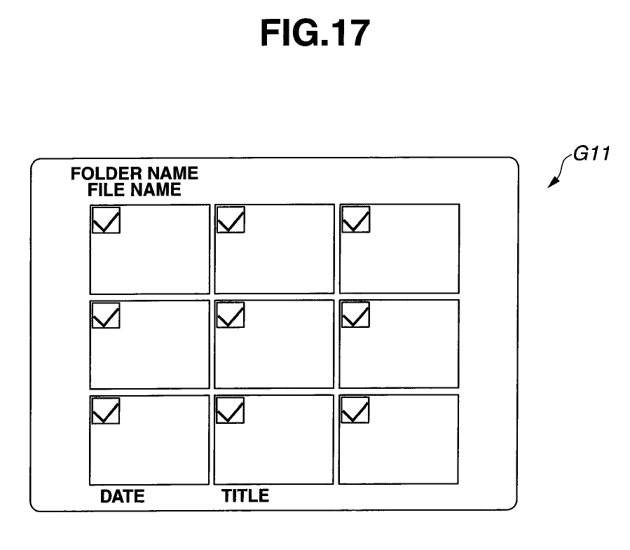

FIG. 17 is a view showing an example of the retrieve screen. As shown in FIG. 17, the retrieve screen G11 is a screen on which the recorded images such as the still images recorded in the storage medium 15 as thumbnails. FIG. 17 illustrates nine thumbnail images displayed in matrix.

Each of the thumbnail images displayed on the retrieve screen G11 in FIG. 17 is displayed together with a “check” mark display portion indicating a selection state. The user can put or remove the “check” mark on or from each of the thumbnail images. The “check” mark indicates whether or not the image is specified as the processing target among the recorded images. When the retrieve screen G11 is displayed for the first time after the still images and the like were recorded, no check mark is put in any of the “check” mark display portions of the thumbnail images. The thumbnail images are selected as the processing targets by putting the “check” marks in the “check” mark display portions.

When a folder name is assigned to the folder, the assigned folder name is displayed on the upper side of the retrieve screen G11, as shown in FIG. 17.

In addition, the user can select a desired thumbnail image using a cursor, not shown, on the screen shown in FIG. 17. The file name of the thumbnail image in the selected state is shown below the folder name on the retrieve screen G11, and the photographed date and the title corresponding to the thumbnail image are displayed on the lower side of the retrieve screen.

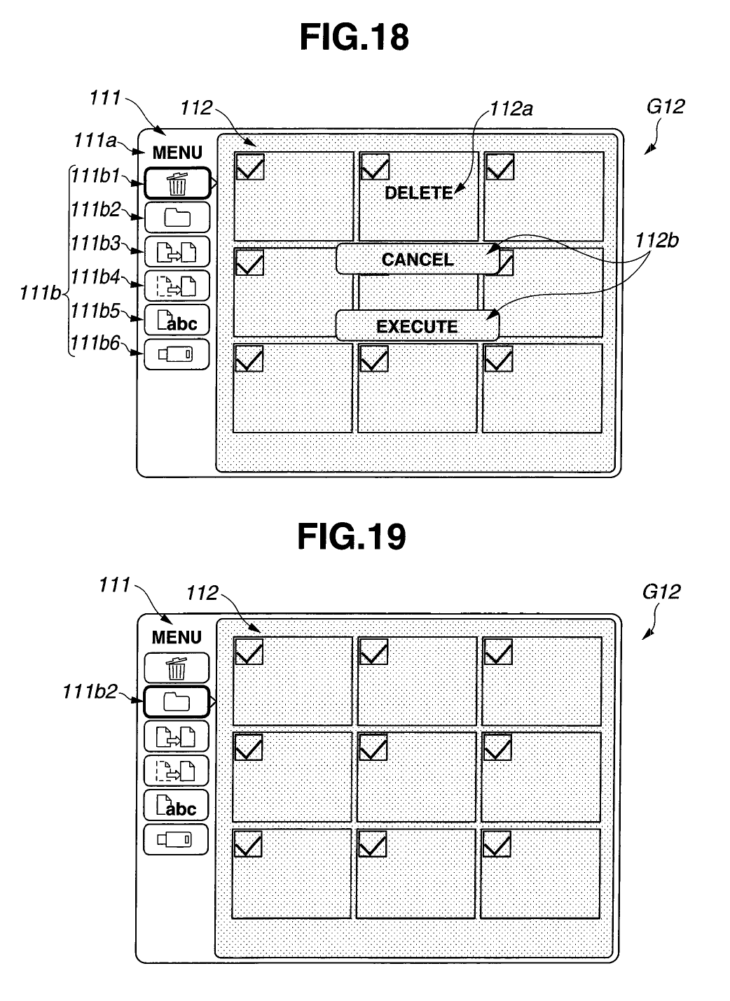

For example, if the user depresses the menu display button 5d after putting the “check” marks on the nine thumbnail images as shown in FIG. 17, the screen as shown in FIG. 18 is displayed.

FIG. 18 is a view showing a configuration of a menu screen of the retrieve screen (hereinafter, referred to as retrieve menu screen) G12. The retrieve menu screen G12 is a Graphical User Interface (GUI) displayed when the menu display button 5d is depressed in the display state of the retrieve screen G11, as shown by the arrow A5 in FIG. 6.

The retrieve menu screen G12 is the highest-level layer screen, and includes a menu item display portion 111 on the retrieve screen including a plurality of menu items, and a lower-level layer display portion 112 for displaying thumbnail images of the recorded still images and the like. As shown in FIG. 18, the retrieve menu screen G12 is displayed in such a manner that the lower-level layer display portion 112 covers a part of the menu item display portion 111 which is a higher-level layer display portion. At this time, the lower-level layer display portion 112 which is a display portion in the lower-level hierarchy is displayed superposed on the higher-level layer display portion 111 such that the items, that is, the items from icons 111b1 to 111b6 on the higher-level layer display portion 111, which is a display portion in the higher-level hierarchy, can be visually identified.

The menu item display portion 111 includes a display area where characters “MENU” 111a indicative of the highest-level layer screen, and a plurality of icons 111b corresponding to a plurality of selectable menu items are displayed. The plurality of icons 111b include six icons arranged so as to align in the vertical direction on the screen.

The uppermost icon 111b1 is an icon for instructing deletion of recorded images. Similarly, an icon 111b2 below the icon 111b1 is an icon for newly creating a folder. An icon 101b3 below the icon 111b2 is an icon for copying a file.

In addition, below the icon 111b3, an icon 111b4 for moving a file, an icon 111b5 for changing a file name, and icon 111b6 for deleting all of the recorded image data are displayed.

The user causes the retrieve menu screen G12 in FIG. 18 to be displayed and selects an icon for a desired processing, thereby capable of executing various processings on the recorded images.

In the present embodiment, setting is made in advance such that the icon 111b1 is displayed in a selectable state when the screen is changed from the retrieve screen G11 to the retrieve menu screen G12 and the retrieve menu screen G12 is displayed.

In FIG. 18, the uppermost icon 111b1 is displayed with bold frame on the menu item display portion 111 on the retrieve menu screen G12, which shows that the icon is in the selectable state. The icon 111b1 which is a selectable item is displayed so as to be distinguished from other items on the higher-level layer display portion 111, by the processing in the step S12 in FIG. 9. The characters “DELETE” 112a corresponding to the icon 111b1 and button displays 112b indicative of two operation items of “CANCEL” and “EXECUTE” are displayed on the grayed-out lower-level layer display portion 112. In particular, the characters “DELETE” 112a indicate the content of the icon 111b1. The icons 112b indicative of the items related to the icon 111b1 of a selectable item are displayed on the lower-level layer display portion 112 by the processing in the step S14 in FIG. 9.

When the joystick 5e is depressed in the state where the icon 111b1 for instructing the deletion of the recorded images is selectable as shown in FIG. 18, the lower-level layer display portion 112 is changed from the grayed-out state to a bright display state and emphasis-displayed, on the other hand, the menu item display portion 111 is brought into a grayed-out state by the processing in the step S11 in FIG. 9, though not shown. In addition, the icon 111b1 is displayed so as to be distinguishable from the icon 11b2 and the like of other items in the higher-level layer display portion 111, by the processing in the step S13 in FIG. 9.

That is, when the user selects a desired item on the retrieve menu screen G12, the screen is changed to the menu screen corresponding to the selected item as shown by the arrow A6 in FIG. 6.

When the user selects one of the two buttons 112b on the lower-level layer display portion 112 and depresses the joystick 5e as a decision button, the selected processing, i.e., deletion processing is executed.

As described above, when the user depresses the menu display button 5d in the state of the retrieve screen G11 shown in FIG. 17, the retrieve menu screen G12 in FIG. 18 is displayed, and the menu item display portion 111 in the selected hierarchy is more emphasis-displayed than the lower-level layer display portion 112 in the lower-level hierarchy and becomes bright by the processing in the step S11 in FIG. 9.

Note that the emphasis display is performed by displaying the lower-level layer display portion 112 in grayed-out manner in the present embodiment. However, an alternative method may be adopted. For example, luminance may be increased or the color may be changed to an eye-catching color only in the layer display portion in the selected hierarchy.

In addition, on the retrieve menu screen G12, a plurality of selectable menu items are displayed in the menu item display portion 111 in the higher-level hierarchy, and the function, i.e., the content of the operation item related to or corresponding to the icon in the selectable state in the menu item display portion 111 are displayed in the grayed-out lower-level layer display portion 112 by the processing in the step S14 in FIG. 9, in a visually identifiable manner for the user.

When the menu display button 5d is depressed in the state where the retrieve menu screen G12 is displayed, the screen display returns to the retrieve screen G11 in FIG. 17, as shown by the arrow A7 in FIG. 6. Furthermore, when the live screen display button 5c is depressed in the state where the retrieve screen G11 is displayed, the screen returns to the live/freeze screen G1 as shown by the arrow A8 in FIG. 6.

In a case of selecting the icon 111b2 for creating a new folder, when the user tilts the joystick 5e downward in the display state shown in FIG. 18, the icon 111b2 is displayed with bold frame and brought into the selectable state as shown in FIG. 19, by the processing in the step S12 in FIG. 9. FIG. 19 is a view showing the menu screen G12 on which the icon 111b2 is in the selectable state.

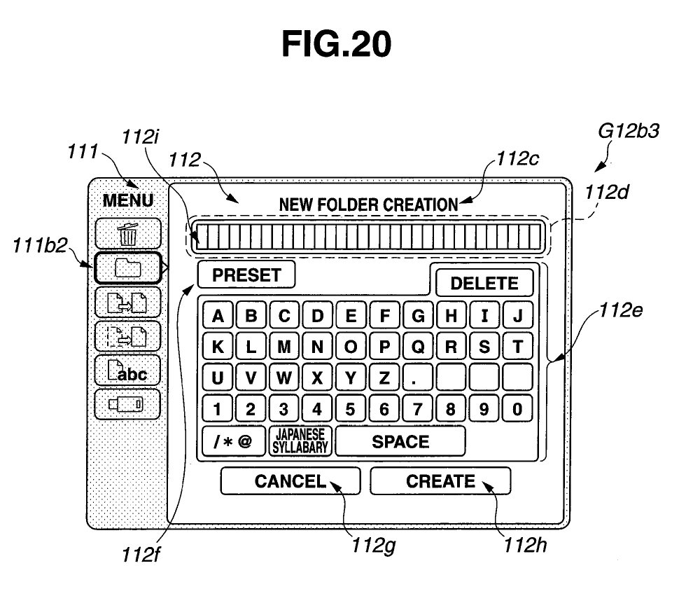

When the joystick 5e as the decision button is depressed in the display state shown in FIG. 19, the selected processing, that is, the processing of creating a new folder is executed. FIG. 20 is a view showing the screen G12b3 for creating a new folder.

As shown on the screen G12b3 in FIG. 20, the characters “NEW FOLDER CREATION” 112c indicating that the lower-level layer display portion 112 relates to creation of a new folder, a folder name input field 112d shown by the dotted lines, a software keyboard display portion 112e, a preset button 112f, a cancel button 112g, create button 112h, and a cursor 102i indicative of the character input position are displayed on the lower-level layer display portion 112. The folder name input field 112d, the software keyboard display portion 112e, the preset button 112f, the cancel button 112g, the create button 112h, and the cursor 102i indicative of the character input position have the same functions as those of the title input field 102b, the software keyboard display portion 102d, the preset button 102e, the cancel button 102g, the create button 102h, and the cursor 102i described with reference to FIG. 9, respectively. Accordingly, descriptions on how to use these buttons are omitted.

Note that the folder name may be inputted by using the methods described above with reference to FIGS. 12 to 16.

Also in FIG. 20, the lower-level display portion 112 is displayed in a more emphasized manner than the higher-level layer display portion 111 by the processing in the S11 in FIG. 9. In addition, by the processing in the step S13 in FIG. 9, the icon 111b2 related to the active lower-level layer display portion 112 is displayed on the higher-level layer display portion 111 so as to be distinguishable from the icons 111b1, 11b3, and the like of other items.

### 5. Other Menu Items

Next, description will be made on other menu items related to the menu screen G2 and the retrieve menu screen G12.

### 5.1 Menu Screen G2

Description will be made on processings to be performed by selecting the icons 101b2 to 101b6 on the menu screen G2.

The user can allow an arbitrary item on the menu item display portion 101 to be in a selectable state by tilting the joystick 5e in the up/down direction. The icon in the selectable state is displayed with bold frame.

### (White Balance)

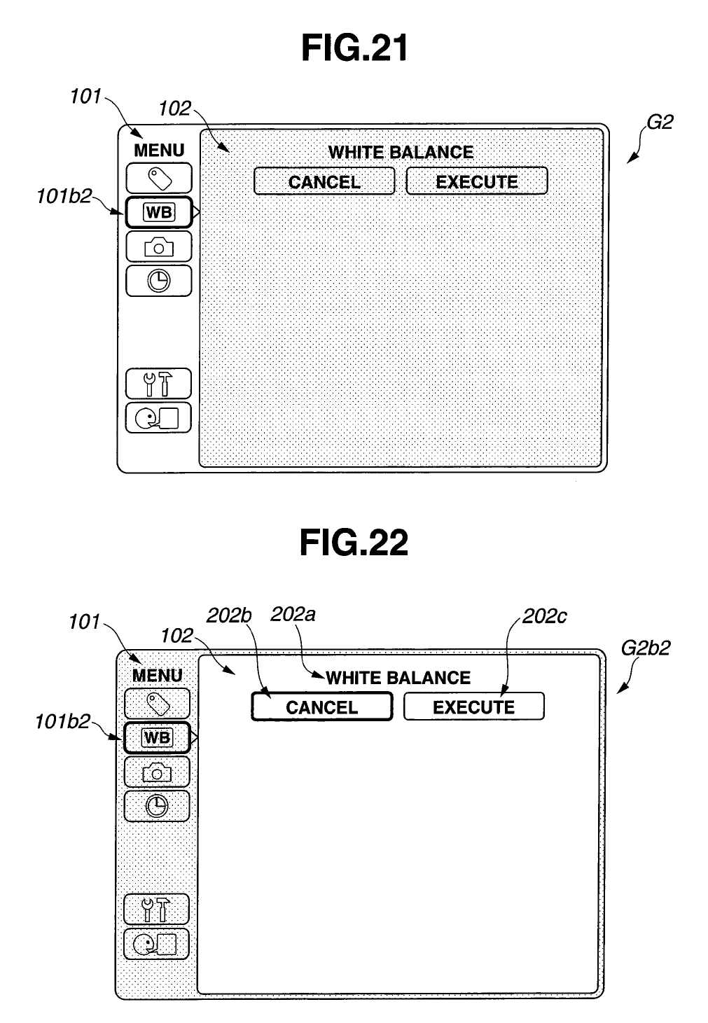

FIG. 21 is a view showing that the icon 101b2 is in the selectable state. When the joystick 5e is depressed or tilted rightward in the display state shown in FIG. 21, the icon 101b2 for white balance adjustment is selected, and the lower-level layer display portion 102 is emphasis-displayed and becomes bright. In the case shown in FIG. 21, the higher-level layer display portion 101 is displayed in a more emphasized manner than the lower-level layer display portion 102 by the processing in the step S11 in FIG. 9. The icon 101b2 of the item in the selectable state is displayed on the higher-level layer display portion 101 such that the icon 101b2 is distinguishable from the icons 101b1, 101b3 and the like of other items, by the processing in the step S12 in FIG. 9. In addition, by the processing in the step S14 in FIG. 9, the items related to the selectable item on the active higher-level layer display portion 101 are displayed on the lower-level layer display portion 102.

FIG. 22 is a view showing a menu screen G2b2 in a white balance executable state. As shown in FIG. 22, when the screen becomes white balance executable state, the higher-level layer display portion 101 is grayed out and the lower-level layer display portion 102 is emphasis-displayed and becomes bright. Furthermore, on the higher-level layer display portion 101, the icon 101b2 is displayed with bold frame so as to be distinguishable from other icons by the processing in the step S13 in FIG. 9.

A white balance adjustment screen on the lower-level layer display portion 102 includes characters “WHITE BALANCE” 202a indicating that the lower-level layer display portion 102 relates to white balance, and a cancel button 202b and an execute button 202c which indicate operation items.

For example, in FIG. 22, the cancel button 202b is displayed with bold frame by the processing in the step S12 in FIG. 9, which shows that the cancel button is in the selectable state, i.e., executable state. When the joystick 5e is depressed and the cancel button 202b is selected, the white balance adjustment processing is canceled, and the screen returns to the menu screen G2 shown in FIG. 21. When the execute button 202c is selected, the white balance adjustment is executed. When the white balance adjustment processing is completed, the screen returns to the menu screen G2 shown in FIG. 21.

As described above, regarding the white balance adjustment, the method of displaying a picked-up image of an object and nondestructively testing the object according to the present embodiment includes the following steps. First, the user obtains the picked-up image of the object and displays the image on the monitor. In addition, the method includes steps of: displaying a hierarchical menu screen for performing a white balance adjustment processing on the image on the monitor, the hierarchical menu screen including at least two hierarchies; emphasis-displaying a display portion in a higher-level hierarchy selected on the hierarchical menu screen or a display portion in a lower-level hierarchy selected on the hierarchical menu screen, the lower-level hierarchy being derived from an item in the higher-level hierarchy; identifiably displaying the item in the higher-level hierarchy, when the display portion in the selected lower-level hierarchy is emphasis-displayed; identifiably displaying an executable item in the lower-level hierarchy, when the display portion in the selected higher-level hierarchy is emphasis-displayed; emphasis-displaying the display portion in the lower-level hierarchy as a result of a selection of an item of the white balance adjustment processing in the higher-level hierarchy and allowing the white balance adjustment processing to be executed or canceled in the lower-level hierarchy on the hierarchical menu screen; and displaying on the monitor the image on which the white balance adjustment processing was executed or for which the white balance adjustment was canceled in the lower-level hierarchy.

### (Recording)

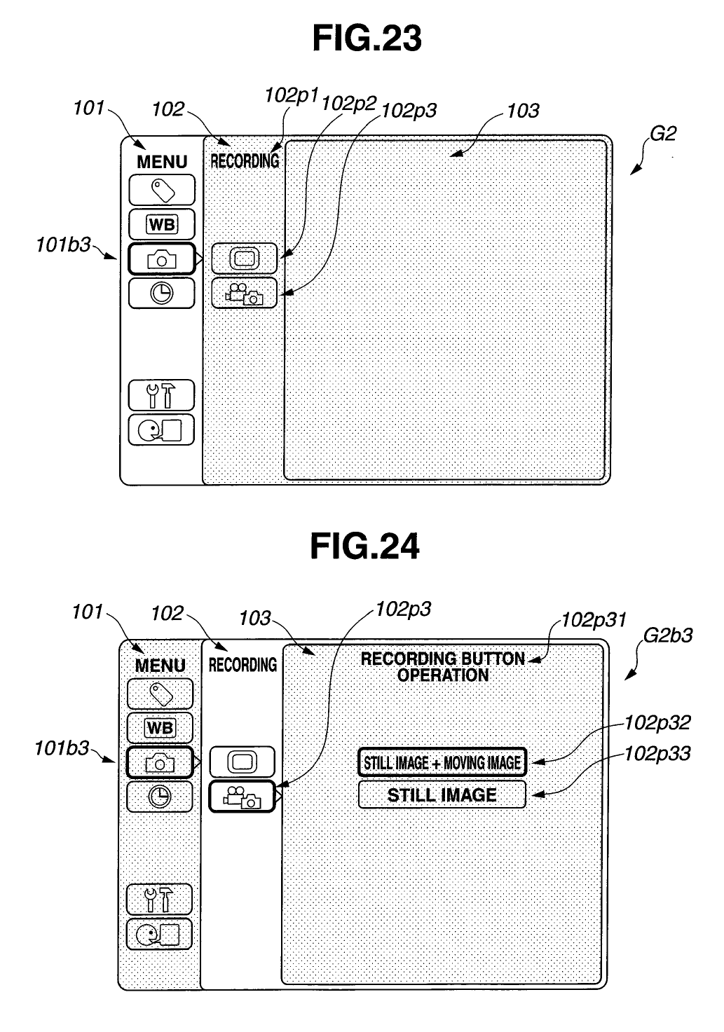

FIG. 23 is a view showing that the icon 101b3 is in a selectable state. When the joystick 5e is tilted downward in the display state shown in FIG. 21 to bring the icon 101b3 for recording into the selectable state, a plurality of selectable items (two icons in the case shown in FIG. 23) related to recording are displayed grayed out on the lower-level layer display portion 102 in a visually identifiable manner for the user by the processing in the step S14 in FIG. 9. Furthermore, in FIG. 23, the higher-level layer display portion 101 is emphasis-displayed by the processing in the step S11 in FIG. 9. On the grayed-out lower-level layer display portion 102, characters “RECORDING” 102p1 indicating that the selected icon relates to recording and two icons 102p2 and 102p3 as selectable items are displayed. The icon 102p2 and the icon 102p3 relate to a print screen and recording button operation, respectively. In FIG. 23, a lower-level layer display portion 103, the layer level of which is further lower than that of the lower-level layer display portion 102, is also displayed grayed out. However, no icon is selected in the lower-level layer display portion 102, so that nothing is displayed on the lower-level layer display portion 103.

In FIG. 23 and in other figures, the display portions in the respective hierarchies are displayed as rectangular windows so as to be superposed on each other from the left to the right direction on the display screen of the monitor when facing the monitor.

When the joystick 5e is depressed or tilted rightward in the display state shown in FIG. 23, the screen changes to the screen shown in FIG. 24. FIG. 24 is a view showing a menu screen G2b3 displayed when the recording operation is selected. In FIG. 24, the lower-level layer display portion 102 is emphasis-displayed and becomes bright by the processing in the step S11 in FIG. 9, and the higher-level layer display portion 101 is displayed grayed out. In FIG. 24, the icon 102p3 of the two selection items is displayed with bold frame by the processing in the step S12 in FIG. 9, which indicates that the icon 102p3 is in a selectable state. Furthermore, the lower-level layer display portion 103, the layer level of which is lower than the layer display portion 102, is displayed grayed out. The grayed-out lower-level layer display portion 103 includes characters “RECORDING BUTTON OPERATION” 102p31 indicating that the icon 102p3 in the selectable state relates to the recording button operation, and two icons 102p32 and 102p33 indicative of “STILL IMAGE+MOVING IMAGE” and “STILL IMAGE”, respectively. That is, as shown in FIG. 24, on the menu screen G2b3, a plurality of selection items corresponding to the item in the selectable state on the lower-level layer display portion 102 are also displayed on the lower-level display portion 103 displayed grayed out.

As described above, characters (“RECORDING” in this case) indicative of the content of the item selected in the higher-level hierarchy are displayed on the display portion in the selected hierarchy, and characters (“RECORDING BUTTON OPERATION” in this case) indicative of the content of the item in the selectable state in the selected hierarchy are displayed on the display portion in the lower-level hierarchy. Furthermore, characters (“STILL IMAGE+MOVING IMAGE” and “STILL IMAGE” in this case) indicative of the content of the item in the lower-level hierarchy are displayed on the display portion in the lower-level hierarchy.

FIG. 24 shows the layer display of three hierarchies. In other words, the highest-level layer display portion 101 is a higher-level layer display portion, the layer display portion 102 is a middle-level layer display portion, and the layer display portion 103 is a lower-level layer display portion. The higher-level layer display portion is displayed under the lower-level layer display portion. However, the lower-level layer display portion is displayed on the higher-level layer display portion such that the items displayed on the higher-level layer display portion can be visually identified, in other words, such that the item displayed on the higher-level layer display portion is not interfered.

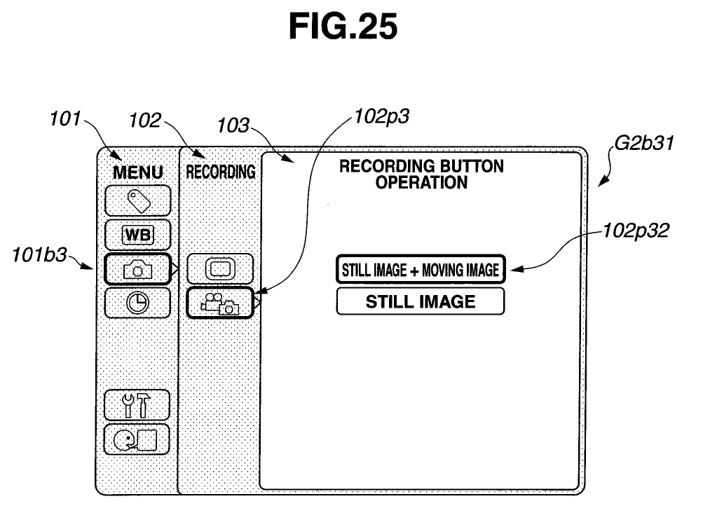

When the joystick 5e is depressed or tilted rightward in the display state shown in FIG. 24 and the icon 102p3 is selected, the screen is changed to a screen shown in FIG. 25. FIG. 25 is a view showing the menu screen G2b31 displayed when the recording button operation is selected.

In FIG. 25, the lowest-level layer display portion 103 is emphasis-displayed and becomes bright by the processing in the step S11 in FIG. 9, and the icon 102p32 as one of the selection items is in the selectable state by the processing in the step S12 in FIG. 9. Furthermore, in FIG. 25, the icons 101b3 and 102p3 of the items related to the lowest-level layer display portion 103 are displayed on the two layer display portions 101, 102 of the higher level, respectively, such that the icons are displayed identifiably, i.e., distinguishably from the icons of other items by the processing in the step S13 in FIG. 9.

In FIG. 24, since the icon 101b3 is identifiably displayed in bold on the grayed-out higher-level layer display portion 101 by the processing in the step S13 in FIG. 9, the user can easily understand that the emphasis-displayed middle-level layer display portion 102 is displayed as a result of the selection of the icon 101b3 on the higher-level layer display portion 101.

In addition, in FIG. 24, by the processing in the step S14 in FIG. 9, the two icons 102p32 and 102p33 are displayed on the grayed-out lower-level layer display portion 103 and the icon 102p32, in particular, is identifiably displayed in bold. Accordingly, the user can easily understand that the icon 102p32 which is one of the two selection items is selected, i.e., set regarding the icon 102p3 in the selectable state on the emphasis-displayed middle-level layer display portion 102. The two icons 102p32 and 102p33 on the lower-level layer display portion 103 are displayed with the characters indicative of the contents of the icons. The icon 102p32 includes the characters “STILL IMAGE+MOVING IMAGE” and the icon 102p33 includes the characters “STILL IMAGE”. Accordingly, the user can easily understand from the display state shown in FIG. 24 that the icon 102p3 relates to the recording button operation, and “STILL IMAGE+MOVING IMAGE” is selected, i.e., set in the recording button operation.

That is, when the plurality of layers having the hierarchical structure are displayed, the user can easily understand that the emphasis-displayed middle-level layer (selected hierarchical layer) is displayed as a result of the selection of which item in the higher-level layer. Furthermore, the user can understand the selected, that is, set contents regarding the icon displayed in the selectable state in the middle-level layer from the lower-level layer.

As described above, regarding the setting of the recording mode of the picked-up image, the method of displaying the picked-up image of an object and nondestructively testing the object according to the present embodiment includes the following steps. First, the user obtains the picked-up image of the object and displays the image on the monitor. Furthermore, the method includes steps of: displaying a hierarchical menu screen for setting a recording mode for recording the image in a storage medium on the monitor, the hierarchical menu screen including at least three hierarchies; emphasis-displaying a display portion in a hierarchy selected on the hierarchical menu screen compared with a display portion in a higher-level hierarchy than the selected hierarchy and a display portion in a lower-level hierarchy than the selected hierarchy, the selected hierarchy being derived from an item in the higher-level hierarchy; identifiably displaying the item in the higher-level hierarchy, when the display portion in the selected hierarchy is emphasis-displayed; identifiably displaying an executable item in the lower-level hierarchy, when the display portion in the selected hierarchy is emphasis-displayed, the lower-level hierarchy being derived from an item in the selected hierarchy; emphasis-displaying the display portion in the lower-level hierarchy as a result of a selection of an item of the recording mode setting and allowing the recording mode to be selected in the lower-level hierarchy on the hierarchical menu screen; displaying the image on the monitor after the selection of the recording mode in the lower-level hierarchy; and recording the image according to the selected recording mode after the selection of the recording mode in the lower-level hierarchy.

### (Date and Time Setting)

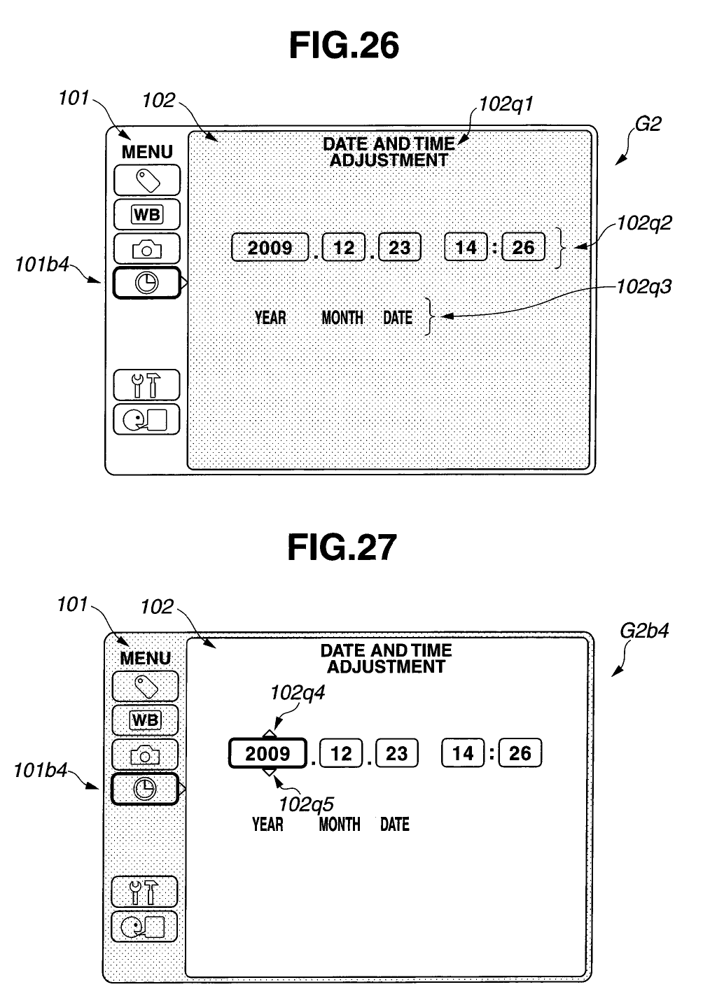

FIG. 26 is a view showing that the icon 101b4 is in a selectable state. When the joystick 5e is depressed or tilted rightward in the display state shown in FIG. 26, the icon 101b4 for date and time setting is selected. Then, as shown in FIG. 27, the higher-level layer display portion 101 is grayed out and the lower-level layer display portion 102 is emphasis-displayed and becomes bright by the processing in the step S11 in FIG. 9. As shown in FIG. 26, on the grayed-out lower-level layer display portion 102, characters “DATE AND TIME SETTING” 102q1 indicating that the lower-level layer relates to the date and time setting, a date and time display portion 102q2 for displaying set time and date, and an arranging order display portion 102q3 for displaying the arranging order of the set “year”, “month” and “date” are displayed.

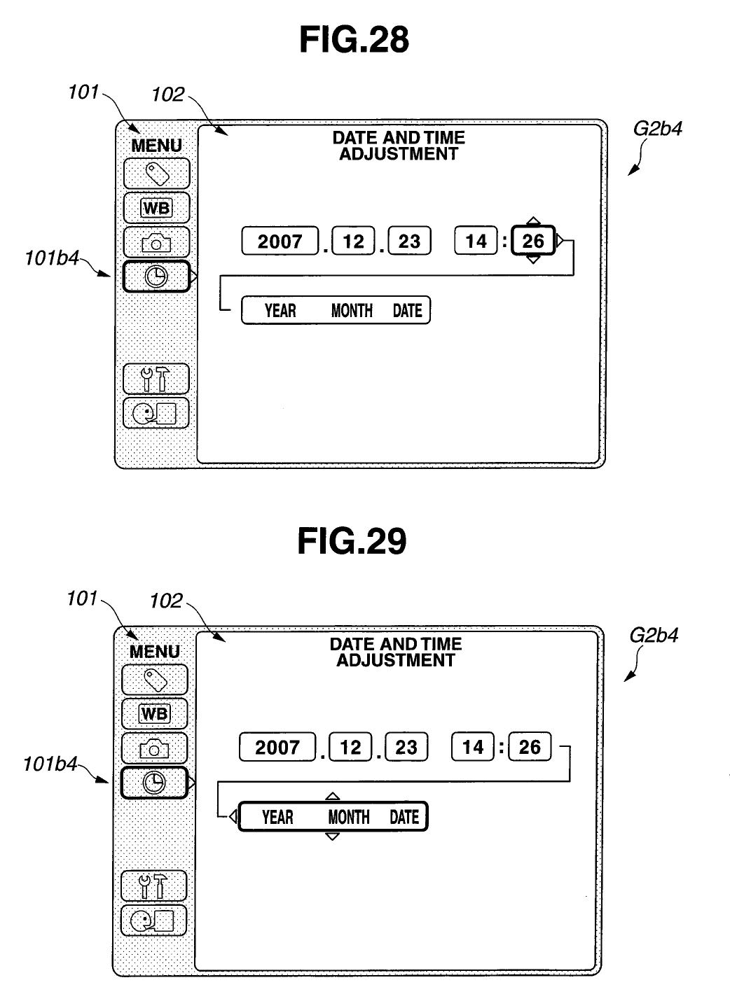

FIGS. 27 to 29 are views showing a menu screen G2b4 in the date and time setting executable state. As shown in FIGS. 27 to 29, a setting portion for “year” is shown with bold frame in FIG. 27, for example, and marks 102q4, 102q5 indicative of increase and decrease of the numeric characters are displayed above and below the setting portion, respectively. The user can set a desired “year” by tilting the joystick 5e in the up/down direction. The user tilts the joystick 5e rightward or leftward and decides an item to be set by shifting the bold frame to each of the setting portions for “month”, date”, “hour”, and “minute”, thereby capable of setting a desired “month” and the like, similarly as “year”. In FIG. 28, the setting portion for “minute” is displayed with bold frame. In FIG. 29, the arranging order display portion 102q3 indicative of the arranging order of the “year”, “month” and “date” is displayed with bold frame. The user tilts the joystick 5e rightward, thereby capable of moving the bold frame (item to be set) from the setting portion for “minute” in FIG. 28 to the arranging order display portion 102q3 in FIG. 29.

The arranging order can be set in an order of “month”, “date” and “year”, or can be set in an order of “date”, “month”, and “year”. When the date and time setting is completed, the screen returns to the menu screen G2 in FIG. 26. In FIG. 26, the set date and time are displayed on the lower-level layer display portion 102 displayed grayed out. The user can return the screen to the menu screen G2 shown in FIG. 26 from the screen state as shown in FIG. 27 also by tilting the joystick 5e to the left.

### (Setup)

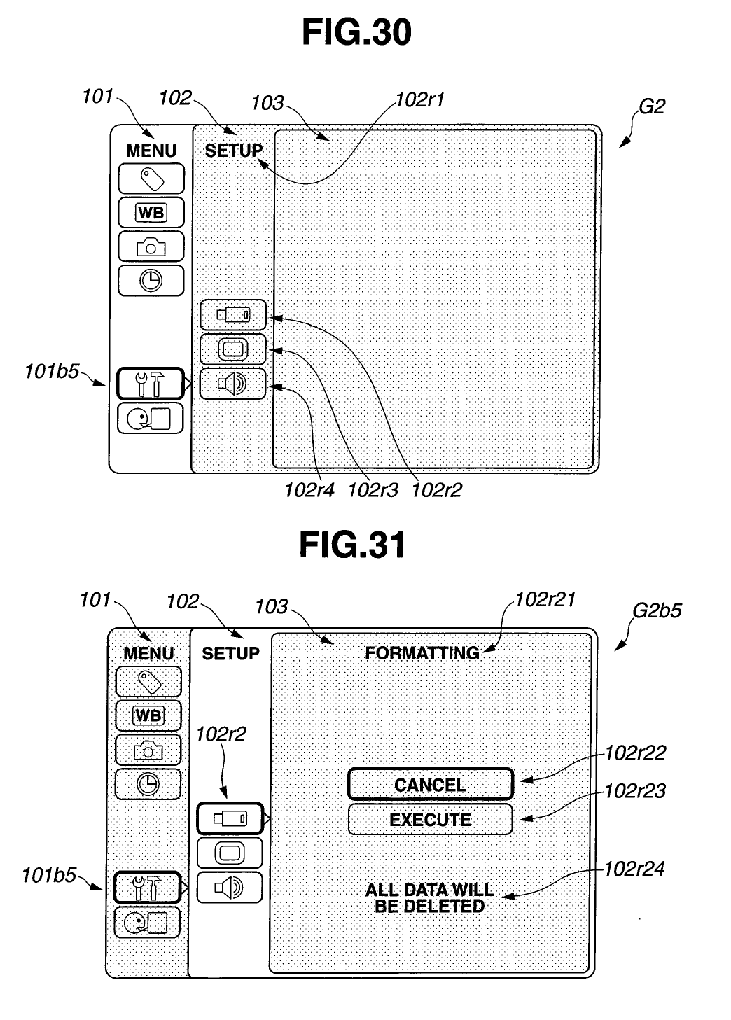

FIG. 30 is a view showing that the icon 101b5 is in a selectable state. When the joystick 5e is depressed in the display state shown in FIG. 26 and the icon 101b5 for the setup operation is selected, a plurality of selectable items (three icons in the case shown in FIG. 30) related to the setup operation are displayed grayed out on the middle-level layer display portion 102 in a visually identifiable manner for the user, by the processing in the step S14 in FIG. 9. On the middle-level layer display portion 102 displayed grayed out, characters “SETUP” 102r1 indicating that the selected icon relates to the setup operation, and three icons 102r2, 102r3, and 102r4 as selectable items are displayed. The icon 102r2 relates to a formatting operation, the icon 102r3 relates to a screen display operation, and the icon 102r4 relates to a beep sound operation. In FIG. 24, the lower-level layer display portion 103, the layer level of which is lower than the middle-level layer display portion 102, is also displayed grayed out. However, since no icon is selected on the middle-level layer display portion 102, nothing is displayed on the lower-level layer display portion 103.

When the joystick 5e is depressed or tilted rightward in the display state shown in FIG. 30, the screen changes to the screen shown in FIG. 31. FIG. 31 is a view showing a menu screen G2b5 displayed when the setup operation is selected. FIG. 31 also shows the layer display of three hierarchies similarly as FIG. 24.

In FIG. 31, by the processing in the step S11 in FIG. 9, the middle-level layer display portion 102 is emphasis-displayed and becomes bright and the higher-level layer display portion 101 is displayed grayed out. In FIG. 31, the first icon 102r2 among the three selectable items is identifiably displayed with bold frame by the processing in the step S12 in FIG. 9, which shows the icon is in a selectable state. Furthermore, the further lower-level layer display portion 103 which corresponds to the icon 102r2 on the middle-level layer display portion 102 is displayed grayed out by the processing in the step S14 in FIG. 9. The lower-level layer display portion 103 displayed grayed out includes characters “FORMATTING” 102r21 indicating that the selected icon relates to the formatting operation, and icons 102r22, 102r23 of the two operation items “cancel” and “execute”. Since the icon “cancel” is displayed in the selectable state, a descriptive text for “cancel” is displayed on a description display portion 102r24. That is, as shown in FIG. 31, on the menu screen G2b5, a plurality of selection items corresponding to the item in the selectable state in the middle-level layer display portion 102 are further displayed on the lower-level layer display portion 103 displayed grayed out.

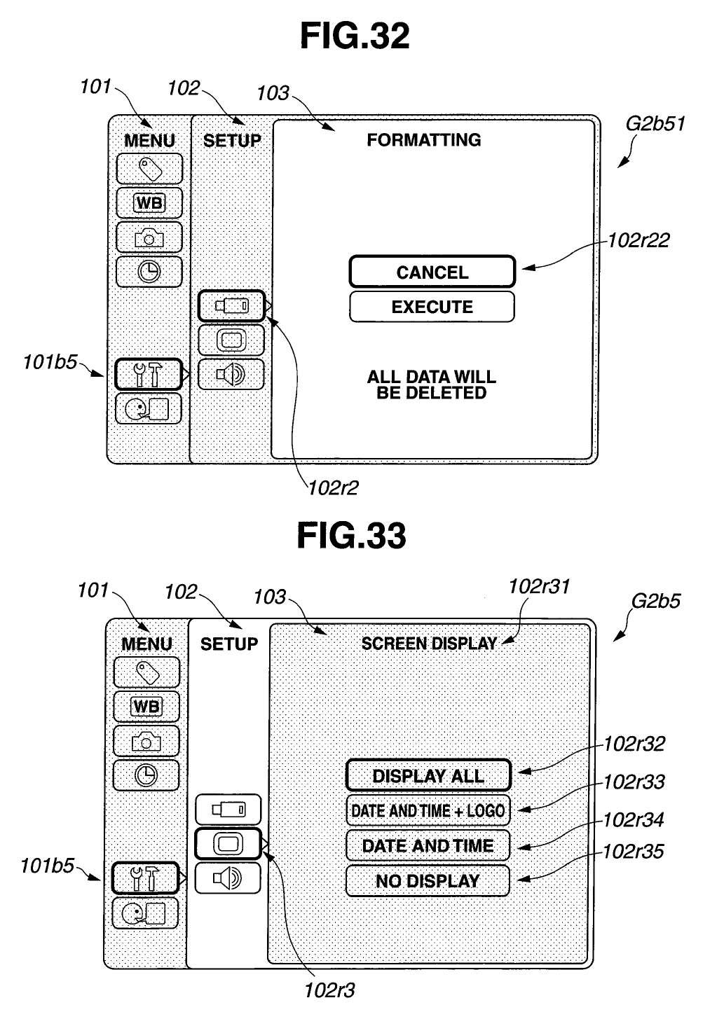

When the joystick 5e is depressed or tilted rightward in the display state shown in FIG. 31 and the icon 102r2 is selected, the screen is changed to the screen shown in FIG. 32. FIG. 32 is a view showing the menu screen G2b51 displayed when the formatting operation is selected.

In FIG. 32, the lowest-level layer display portion 103 is emphasis-displayed and becomes bright by the processing in the step S11 in FIG. 9, and the icon 102r22 which is one of the selection items is in the selectable state.

In FIG. 31, since the icon 101b5 is displayed in bold on the grayed-out higher-level layer display portion 101 by the processing in the step S13 in FIG. 9, the user can easily understand that the emphasis-displayed middle-level layer display portion 102 is displayed as a result of the selection of the icon 101b5 on the higher-level layer display portion 101.

Furthermore, in FIG. 31, the icon 102r22 is displayed in bold on the grayed-out lower-level layer display portion 103 by the processing in the step S14 in FIG. 9. Accordingly, the user can easily understand that the icon 102r22 or the icon 102r23 is executable regarding the icon 102r2 in the selectable state on the emphasis-displayed middle-level layer display portion 102. The two icons 102r22 and 102r23 on the lower-level layer display portion 103 are displayed with characters indicative of the contents of the icons. The icon 102r22 includes the characters “cancel” and the icon 102r23 includes the characters “execute”. Therefore, the user can easily understand that the icon 102r2 relates to the formatting operation from the display state shown in FIG. 31, and “cancel” or “execute” can be set in the formatting operation.

That is, when the plurality of layers having the hierarchical structure are displayed, the user can easily understand that the emphasis-displayed middle-level layer (selected hierarchical layer) is displayed as a result of the selection of which item in the higher-level layer. Furthermore, the user can understand the executable contents regarding the icon in the selectable state in the selected hierarchical layer from the lower-level layer.

As described above, regarding the formatting processing, the method of displaying a picked-up image of an object and nondestructively testing the object according to the present embodiment includes the following steps. First, the user obtains the picked-up image of the object and displays the image on the monitor. Furthermore, the method includes steps of: displaying a hierarchical menu screen for performing a formatting processing of a storage medium for recording the image on the monitor, the hierarchical menu screen including at least three hierarchies; emphasis-displaying a display portion in a hierarchy selected on the hierarchical menu screen compared with a display portion in a higher-level hierarchy than the selected hierarchy and a display portion in a lower-level hierarchy than the selected hierarchy, the selected hierarchy being derived from an item in the higher-level hierarchy; identifiably displaying the item in the higher-level hierarchy, when the display portion in the selected hierarchy is emphasis-displayed; identifiably displaying an executable item in the lower-level hierarchy, when the display portion in the selected hierarchy is emphasis-displayed, the lower-level hierarchy being derived from an item in the selected hierarchy; emphasis-displaying the display portion in the lower-level hierarchy as a result of a selection of an item of the formatting processing and allowing the formatting processing to be executed or canceled in the lower-level hierarchy on the hierarchical menu screen; and displaying the image on the monitor after the formatting processing performed in the lower-level hierarchy.

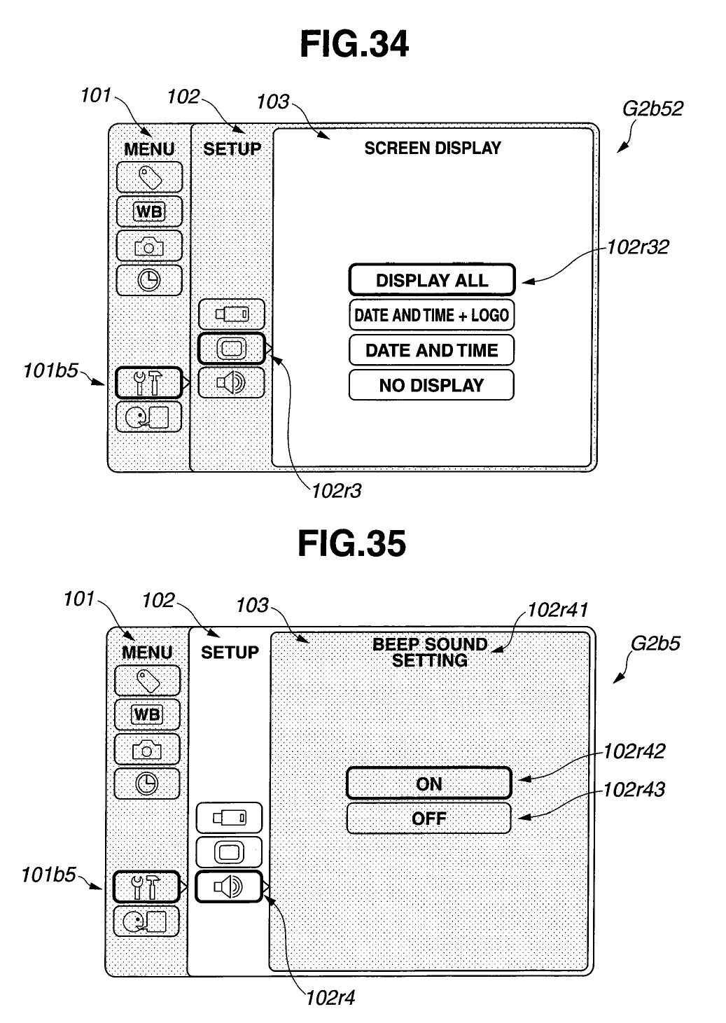

When the joystick 5e is tilted downward in the display state shown in FIG. 31, the screen is changed to the screen shown in FIG. 33. FIG. 33 is a view showing the menu screen G2b5 displayed when the setup operation is selected. When the joystick 5e is depressed or tilted rightward in the display state shown in FIG. 33, the icon 102r3 is selected and the screen is changed to the screen shown in FIG. 34. FIG. 34 is a view showing a menu screen G2b52 displayed when the screen display operation is selected.

In FIG. 34, the lowest-level layer display portion 103 is emphasis-displayed and becomes bright by the processing in the step S11 in FIG. 9, and the icon 102r32 which is one of the selection items is in the selectable state.

In FIG. 33, the icon 101b5 is displayed in bold on the grayed-out higher-level layer display portion 101 by the processing in the step S13 in FIG. 9. Therefore, the user can easily understand that the emphasis-displayed middle-level layer display portion 102 is displayed as a result of the selection of the icon 101b5 on the higher-level layer display portion 101.

In addition, in FIG. 33, the icon 102r32 is identifiably displayed in bold on the grayed-out lower-level layer display portion 103 by the processing in the step S14 in FIG. 9. Therefore, the user can easily understand that the icon 102r32 is selected, i.e., set regarding the icon 102r3 displayed in the selectable state on the emphasis-displayed middle-level layer display portion 102. Four icons 102r32, 102r33, 102r34, and 102r35 on the lower-level layer display portion 103 are displayed with characters indicative of the contents the icons. The icon 102r32 includes characters “DISPLAY ALL”, the icon 102r33 includes characters “DATE AND TIME+LOGO”, the icon 102r34 includes “DATE AND TIME”, and the icon 102r35 includes characters “NO DISPLAY”. Accordingly, the user can easily understand from the display state in FIG. 33 that the icon 102r3 relates to the screen display operation and “DISPLAY ALL” is currently selected, i.e., set in the screen display operation.

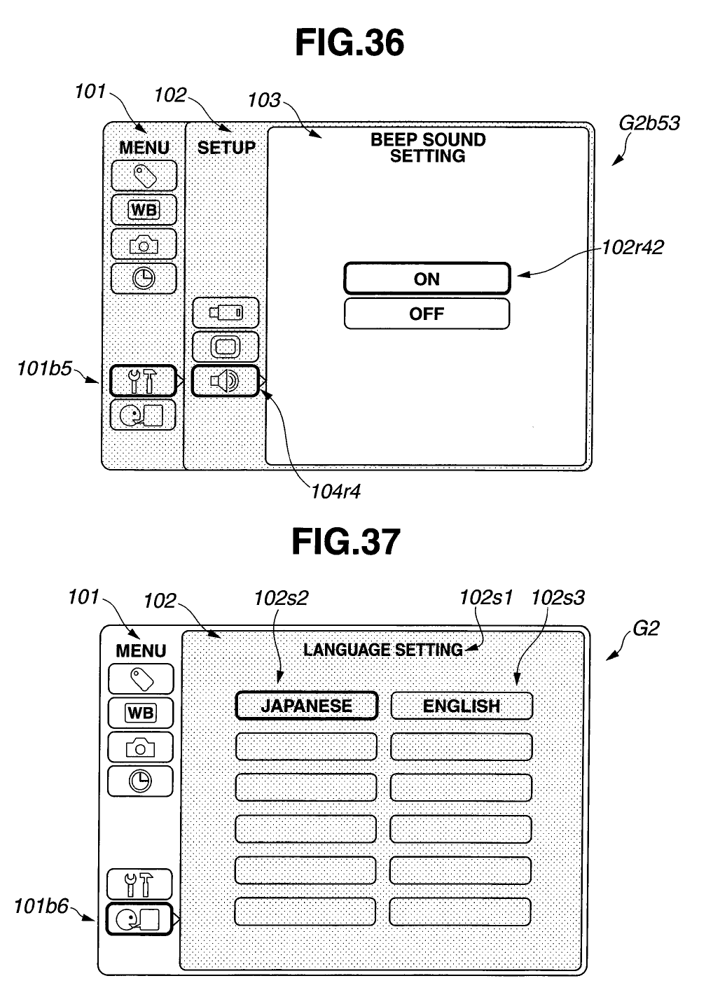

When the joystick 5e is tilted downward in the display state shown in FIG. 33, the screen is changed to the screen shown in FIG. 35. FIG. 35 is a view showing the menu screen G2b5 displayed when the setup operation is selected. When the joystick 5e is depressed or tilted rightward in the display state shown in FIG. 35, the icon 102r4 is selected and the screen is changed to the screen shown in FIG. 36. FIG. 36 is a view showing a menu screen G2b53 displayed when the beep sound setting operation is selected.

In FIG. 36, the lowest-level layer display portion 103 is emphasis-displayed and becomes bright by the processing in the step S11 in FIG. 9, and an icon 102r42 which is one of the selection items is in the selectable state.

In FIG. 35, since the icon 101b5 is identifiably displayed in bold on the grayed-out higher-level layer display portion 101 by the processing in the step S13 in FIG. 9, the user can easily understand that the emphasis-displayed middle-level layer display portion 102 is displayed as a result of the selection of the icon 101b5 on the higher-level layer display portion 101.

In addition, in FIG. 35, the icon 102r42 is identifiably displayed in bold on the grayed-out lower-level layer display portion 103 by the processing in step S14 in FIG. 9. Accordingly, the user can easily understand that either one of the two icons 102r42, 102r43 is settable regarding the icon 102r4 displayed in the selectable state on the emphasis-displayed middle-level layer display portion 102, and the icon 102r42 is selected, i.e., set. The two icons 102r42 and 102r43 on the lower-level-layer display portion 103 displayed with characters indicative of the contents the icons. The icon 102r42 includes characters “ON”, and the icon 102r43 includes characters “OFF”. Therefore, the user can easily understand from the display state shown in FIG. 35 that the icon 102r4 relates to the beep sound setting operation, and “ON” is currently set in the beep sound setting.

### (Language Setting)

When the joystick 5e is tilted downward in the display state shown in FIG. 30, the screen is changed to the screen shown in FIG. 37.

FIG. 30 is a view showing that the icon 101b6 is in a selectable state. When the joystick 5e is depressed or tilted rightward in the display state shown in FIG. 37, the icon 101b6 for language setting is selected. The display for instructing execution of language setting is emphasis-displayed and becomes bright on the lower-level layer display portion 102, though not shown.

As shown in FIG. 37, characters “LANGUAGE SETTING” 102s1 indicating that the lower-level layer relates to the language setting operation and a plurality of settable languages (two languages in the present embodiment) are displayed on the grayed-out lower-level layer display portion 102 by the processing in the step S14 in FIG. 9. In FIG. 37, the settable languages are displayed with characters “JAPANESE” and “ENGLISH” on buttons 102s2 and 102s3. As shown in FIG. 37, the button 102s2 is identifiably displayed with bold frame by the processing in the step S14 in FIG. 9, and the user can understand that “JAPANESE” is currently selected.

### 5.2 Menu Screen G12

As shown in FIG. 18, the menu screen G12 includes four more icons in addition to the above-described icons 111b1, 111b2. Description will be made on the processings indicated by the icons 111b3 to 111b6.

The user can allow an arbitrary icon among the icons on the menu item display portion 101 to be in the selectable state by tilting the joystick 5e in the up/down direction in the display state shown in FIG. 18. The frame of the icon in the selectable state is displayed with bold frame.

### (File Copying)

The icon 111b3 in FIG. 18 is an icon for file copying operation. The icon 111b3 is used when creating a copy of a file.

### (File Moving)

The icon 111b4 in FIG. 18 is an icon for file moving operation. The icon 111b4 is used when the user moves a file which he or she desires to move from a certain folder to another holder.

### (File Name Change)

The icon 111b5 in FIG. 18 is an icon for changing a file name.

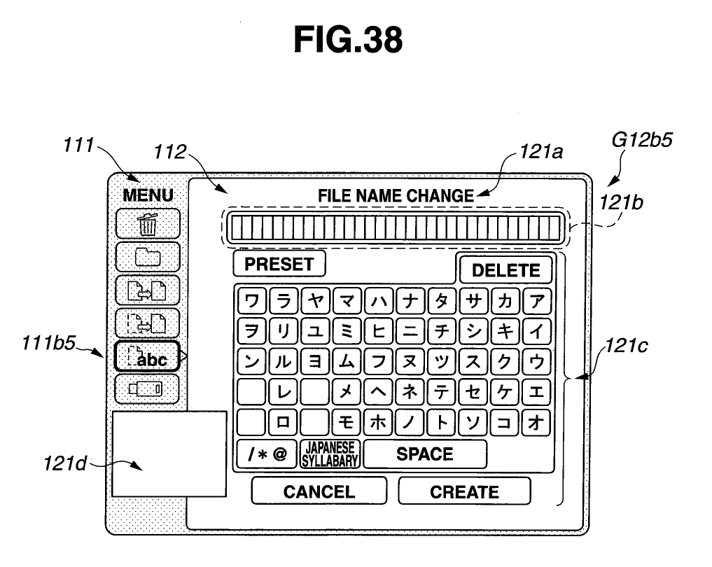

FIG. 38 shows a screen G12b5 displayed when the icon 11b5 is selected. When the image file is in the DCF format, for example, the file name is specified conforming to the DCF standard. Now description will be made on a case where the user desires to change the file name. As shown in FIG. 38, a lower-level layer display portion 112 includes the characters 121a indicating that the active lower-level layer display portion 112 relates to the file name changing operation, and a file name input field 121b arranged under the characters 121a. In addition, a region 121c in which various buttons, a software keyboard and the like for inputting characters are displayed is arranged under the file name input field 121b. Furthermore, a region 121d for displaying the thumbnail image of the image whose file name is to be changed is arranged at a part of the screen.

Initially, the file name is automatically created and attached to each image. When the user changes the name of the file, the initially attached or previously changed file name is displayed in the file name input field 121b. The user can change the file name by editing the current file name using the various keys, the buttons and the like in the region 121c.

### 6. Screen Transition

As described above, the screen displayed on the LCD 4 transits according to a predetermined operation by the user. Here, the above-described screen transition will be summarized and briefly described.

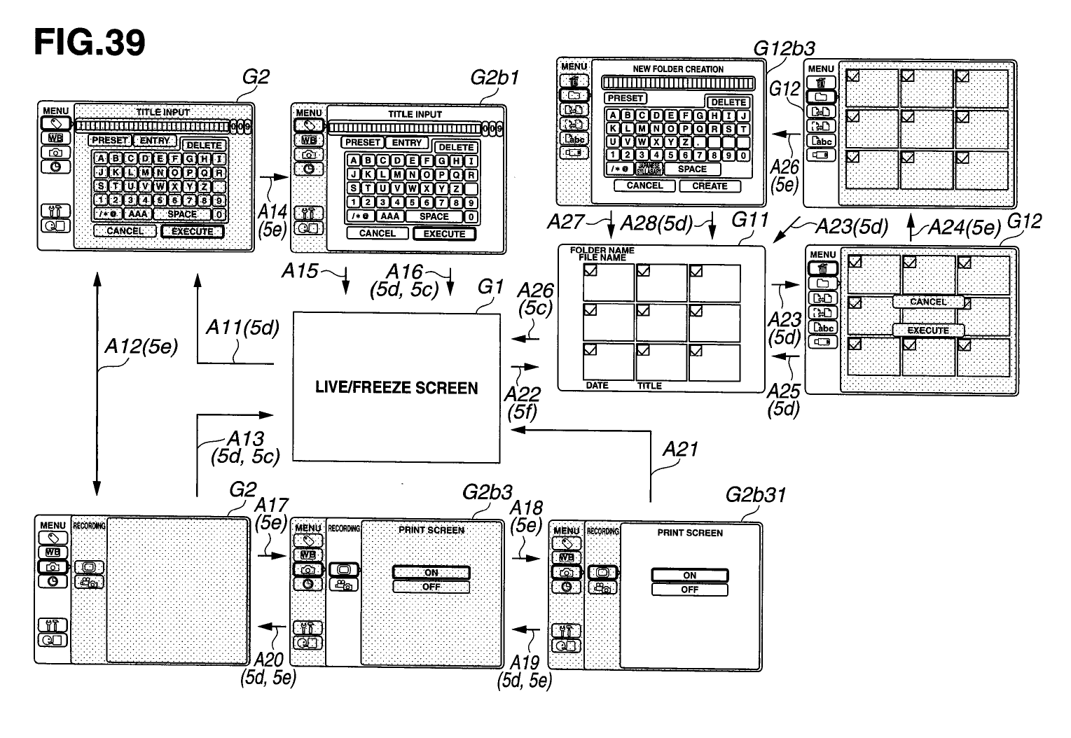

Hereinafter, though description will be made on FIG. 39 by using examples in which some items are selected on the menu screen G2 and the retrieve menu screen G12, the screens displayed as the results of selection of the respective items are as described above.

FIG. 39 is a view showing a transition of the screen on the LCD 4 of the endoscope apparatus 1. When the menu display button 5d is depressed in the state where the live/freeze screen G1 is displayed, the display on the screen transits from the live/freeze screen G1 to the menu screen G2 as shown by the arrow A11. When the joystick 5e is tilted in the up/down direction in the state where the menu screen G2 is displayed, the display on the menu screen G2 is brought into the state where the menu item is selectable, as shown by the arrow A12. When the menu display button 5d or the live screen display button 5c is depressed in the state where the menu screen G2 is displayed, the display on the screen transits from the menu screen G2 to the live/freeze screen G1 as shown by the arrow A13.

When the joystick 5e is depressed or tilted rightward in the state where the icon for title input is selected on the menu screen G2, the display on the screen transits to the menu screen G2b1 in the title input enable state, as shown by the arrow A14.

When the cancel button is selected on the menu screen G2b1, the display on the screen transits from the menu screen G2b1 to the live/freeze screen G1 as shown by the arrow A15. In addition, when the menu display button 5d or the live screen display button 5c is depressed in the state where the menu screen G2b1 is displayed, the display on the screen transits from the menu screen G2b1 to the live/freeze screen G1 as shown by the arrow A16.

When the joystick 5e is depressed or tilted rightward in the state where an icon other than the icon for title input is selected on the menu screen G2, the display on the screen transits to the state where the lower-level layer display portion related to the item selected on the menu screen G2 is emphasis-displayed. When there is a selection item on the emphasis-displayed lower-level layer display portion, if the user allows the icon of the selection item to be in the selectable state and then depresses or tilts rightward the joystick 5e, the lower-level layer display portion related to the selected item is emphasis-displayed on the screen as shown by the arrow A18. FIG. 39 shows an example in which the icon for item of recording is selected, the display on the screen transits to the screen G2b3, and subsequently to the screen G2b31.

When the menu display button 5d is depressed or the joystick 5e is tilted leftward in the case where the lower-level layer display portion is emphasis-displayed, the display on the screen transits to the screen on which the higher-level layer display portion is emphasis-displayed, as shown by the arrows A19 and A20.

When the user selects setting or execution of the function of the item on the lower-level layer display portion, the display on the screen returns to the live/freeze screen G1 as shown by the arrow A21.

When the view button 5f is continued to be pressed for a long time in the state where the live/freeze screen G1 is displayed, the display on the screen transits from the live/freeze screen G1 to the retrieve screen G11 as shown by the arrow A22.

When the menu display button 5d is depressed in the state where the retrieve screen G11 is displayed, the display on the screen transits from the retrieve screen G11 to the retrieve menu screen G12 as shown by the arrow A23. When the joystick 5e is tilted in the up/down direction in the state where the retrieve menu screen G12 is displayed, the display on the retrieve menu screen G12 is brought into the state where the menu item can be selected as shown by the arrow A24.

When the menu display button 5d is depressed in the state where the retrieve menu screen G12 is displayed, the display on the screen transits from the retrieve menu screen G12 to the retrieve screen G11 as shown by the arrow A25.

When the live screen display button 5c is depressed in the state where the retrieve screen G11 is displayed, the display on the screen transits from the retrieve screen G11 to the live/freeze screen G1 as shown by the arrow A26.

When the joystick 5e is depressed or tilted rightward in the state where the icon for new folder creation is selected on the retrieve menu screen G12, the display on the screen transits to the screen G12b3 for new folder creation as shown by the arrow A26.

When the cancel button is selected on the screen G12b3 for new folder creation, the display on the screen transits from the menu screen G12b3 to the retrieve screen G11 as shown by the arrow A27. In addition, when the menu display button 5d is depressed in the state where the screen G12b3 for new folder creation is displayed, the display on the screen transits from the screen G12b3 to the retrieve screen G11 as shown by the arrow A28.

As described above, the method of displaying a picked-up image of an object and nondestructively testing the object according to the present embodiment includes the following steps. First, the user obtains the picked-up image of the object and displays the image on the monitor. Furthermore, the method includes steps of: displaying a hierarchical menu screen for performing a setting related to recording of the image or change in the setting on the monitor, the hierarchical menu screen including at least three hierarchies; emphasis-displaying a display portion in a hierarchy selected on the hierarchical menu screen compared with a display portion in a higher-level hierarchy than the selected hierarchy and a display portion in a lower-level hierarchy than the selected hierarchy, the selected hierarchy being derived from an item in the higher-level hierarchy; identifiably displaying the item in the higher-level hierarchy, when the display portion in the selected hierarchy is emphasis-displayed; identifiably displaying a content of an already-set item among items in the lower-level hierarchy, when the display portion in the selected hierarchy is emphasis-displayed, the lower-level hierarchy being derived from an item in the selected hierarchy; emphasis-displaying the display portion in the lower-level hierarchy as a result of a selection of the lower-level hierarchy and allowing the setting or a change in the setting to be performed in the lower-level hierarchy on the hierarchical menu screen; displaying the image on the monitor after the setting or the change in the setting performed in the lower-level hierarchy; and recording the image based on the setting or the change in the setting performed in the lower-level hierarchy.

As described above, according to the endoscope apparatus 1 of the above-described present embodiment, even if the user does not select the item corresponding to a desired function in each of the hierarchies on the menu screen, the user can grasp the relationship between the selected hierarchy and the item in the higher-level hierarchy, and the set contents in the lower-level hierarchy. As a result, it is not necessary for the user to perform conventional troublesome operations, which increases the efficiency of the testing.

In addition, according to the endoscope apparatus 1 of the above-described present embodiment, it is possible to input a text such as a title with a simple operation. Therefore, it is not necessary for the user to perform conventional troublesome operations, which increases the efficiency of the testing.

Note that the above-described endoscope apparatus is a kind of nondestructive testing apparatuses, and the above described text input method according to the above-described present embodiment can be also applied to a nondestructive testing apparatus which obtains an ultrasonic image and the like as test data.

In addition, unless departing from the scope of the present invention, the steps in each of the procedures in the present embodiment and claims may be executed in a different order, and multiple steps in each of the procedures may be executed at the same time, or the execution order of the steps may be different for each of the procedures.

The present invention is not limited to the embodiment described above, and various modifications can be made without departing from the gist of the present invention in implementation of the present invention.

What is claimed is:

1. A nondestructive testing apparatus comprising:
a menu display instruction section for inputting an instruction for displaying a menu screen in a hierarchical structure on a monitor; and
a display control section which emphasis-displays a display portion in a hierarchy selected on the menu screen displayed in response to the instruction by the menu display instruction section compared with a display portion in a higher-level hierarchy than the selected hierarchy and a display portion in a lower-level hierarchy than the selected hierarchy, the selected hierarchy being derived from an item in the higher-level hierarchy, and which identifiably displays the item in the higher-level hierarchy, and identifiably displays an already-set item among items in the lower-level hierarchy, when the display portion in the selected hierarchy is emphasis-displayed, the lower-level hierarchy being derived from an item in the selected hierarchy.

2. The nondestructive testing apparatus according to claim 1, wherein
the display control section displays the display portion in the selected hierarchy so as to be superposed on the display portion in the higher-level hierarchy such that the item in the higher-level hierarchy can be visually identified, and displays the display portion in the lower-level hierarchy so as to be superposed on the display portion in the selected hierarchy such that the item in the selected hierarchy can be visually identified.

3. The nondestructive testing apparatus according to claim 1, wherein the items in the respective hierarchies are displayed as icons.

4. The nondestructive testing apparatus according to claim 3, wherein an item in a selectable state in the selected hierarchy is displayed highlighted or a frame of the icon is displayed in bold.

5. The nondestructive testing apparatus according to claim 2, wherein the display portions in the respective hierarchies are displayed as rectangular windows.

6. The nondestructive testing apparatus according to claim 5, wherein the display portions in the respective hierarchies are superposed on each other from a left to right direction on a display screen on the monitor.

7. The nondestructive testing apparatus according to claim 1, wherein characters indicative of a content of an item selected in the higher-level hierarchy are displayed on the display portion in the selected hierarchy, and characters indicative of a content of an item in a selectable state in the selected hierarchy are displayed on the display portion in the lower-level hierarchy.

8. The nondestructive testing apparatus according to claim 1, wherein characters indicative of a content of an item in the lower-level hierarchy are displayed on the display portion in the lower-level hierarchy.

9. The nondestructive testing apparatus according to claim 1, wherein the display control section emphasis-displays the display portion in the selected hierarchy by displaying the display portion in the higher-level hierarchy and the display portion in the lower-level hierarchy in a grayed-out manner.

10. The nondestructive testing apparatus according to claim 1, wherein the nondestructive testing apparatus is capable of recording image data as test data, and the menu screen displays, in the hierarchical structure, the display portions on which at least one of a title input operation, a white balance setting operation and a recording setting operation can be performed on the image data.

11. The nondestructive testing apparatus according to claim 10, wherein
the nondestructive testing apparatus is an endoscope apparatus which includes: an insertion portion having at a distal end portion thereof an image pickup device; and a main body unit to which the insertion portion is connected, the main body unit including the monitor, and
the image data is an endoscopic image obtained by the endoscope apparatus.

12. A nondestructive testing apparatus which is capable of recording test data, comprising:
a menu display instruction section for inputting an instruction for displaying a menu on a monitor; and
a text input screen display section which allows a text input screen for inputting text data related to the test data to be displayed in a selectable state on the monitor when the instruction for displaying the menu is given by the menu display instruction section.

13. The nondestructive testing apparatus according to claim 12, further comprising:
a decision instruction section for instructing selection decision of a selectable item in the displayed menu; and
a text input state change section which changes a state of the text input screen such that the text data is inputtable in a text input field in the text input screen when the selection decision is instructed by the decision instruction section in a state where the text input screen is displayed in a selectable state.

14. The nondestructive testing apparatus according to claim 12, wherein when an already-inputted text related to the test data exists, the text input screen is displayed in the selectable state with the already-inputted text being displayed.

15. The nondestructive testing apparatus according to claim 12, wherein the nondestructive testing apparatus is capable of recording image data as the test data.

16. The nondestructive testing apparatus according to claim 15, wherein
the nondestructive testing apparatus is an endoscope apparatus which includes: an insertion portion having at a distal end portion thereof an image pickup device; and a main body unit to which the insertion portion is connected, the main body unit including the monitor; and
the image data is an endoscopic image obtained by the endoscope apparatus.

17. The nondestructive testing apparatus according to claim 16, wherein selectable items in the displayed menu include items of title input, white balance setting and recording setting regarding the image data.

18. A nondestructive testing apparatus which is capable of recording image data obtained by an endoscope as test data, comprising:
a menu display instruction section for inputting an instruction for displaying a menu on a monitor;
a text input screen display section which allows a text input screen for inputting text data related to the test data to be displayed in a selectable state on the monitor when the instruction for displaying the menu is given by the menu display instruction section; and
a display control section which emphasis-displays a display portion in a hierarchy selected on a screen of the menu displayed in response to the instruction by the menu display instruction section compared with a display portion in a higher-level hierarchy than the selected hierarchy and a display portion in a lower-level hierarchy than the selected hierarchy, the selected hierarchy being derived from an item in the higher-level hierarchy, and which identifiably displays the item in the higher-level hierarchy, and identifiably displays an already-set item among items in the lower-level hierarchy, when the display portion in the selected hierarchy is emphasis-displayed, the lower-level hierarchy being derived from an item in the selected hierarchy.

19. The nondestructive testing apparatus according to claim 18, wherein the display control section displays the display portion in the selected hierarchy so as to be superposed on the display portion in the higher-level hierarchy such that the item in the higher-level hierarchy can be visually identified, and displays the display portion in the lower-level hierarchy so as to be superposed on the display portion in the selected hierarchy such that the item in the selected hierarchy can be visually identified.

20. The nondestructive testing apparatus according to claim 18, further comprising:
a decision instruction section for instructing selection decision of a selectable item in the displayed menu; and
a text input state change section which changes a state of the text input screen such that the text data is inputtable in a text input field in the text input screen when the selection decision is instructed by the decision instruction section in a state where the text input screen is displayed in the selectable state.

21. A method of displaying a picked-up image of an object and nondestructively testing the object: comprising:
obtaining the picked-up image of the object and displaying the image on a monitor;
displaying a hierarchical menu screen for performing a setting related to recording of the image or change in the setting on the monitor, the hierarchical menu screen including at least three hierarchies;
emphasis-displaying a display portion in a hierarchy selected on the hierarchical menu screen compared with a display portion in a higher-level hierarchy than the selected hierarchy and a display portion in a lower-level hierarchy than the selected hierarchy, the selected hierarchy being derived from an item in the higher-level hierarchy;
identifiably displaying the item in the higher-level hierarchy, when the display portion in the selected hierarchy is emphasis-displayed;
identifiably displaying a content of an already-set item among items in the lower-level hierarchy, when the display portion in the selected hierarchy is emphasis-displayed, the lower-level hierarchy being derived from an item in the selected hierarchy;
emphasis-displaying the display portion in the lower-level hierarchy as a result of a selection of the lower-level hierarchy and allowing the setting or a change in the setting to be performed in the lower-level hierarchy on the hierarchical menu screen;
displaying the image on the monitor after the setting or the change in the setting performed in the lower-level hierarchy; and
recording the image based on the setting or the change in the setting performed in the lower-level hierarchy.

22. The method of nondestructively testing the object according to claim 21, wherein the setting or the change in the setting is a setting of a title of the picked-up image or date and time at which the image is picked up, or a change in the setting.

23. The method of nondestructively testing the object according to claim 22, further comprising,
displaying a software keyboard for performing the setting of the title of the picked-up image or the change in the setting on the monitor, wherein
the setting of the title or the change in the setting is performed using the software keyboard.

24. A method of displaying a picked-up image of an object and nondestructively testing the object: comprising
obtaining the picked-up image of the object and displaying the image on the monitor;
displaying a hierarchical menu screen for performing a white balance adjustment processing on the image on the monitor, the hierarchical menu screen including at least two hierarchies;
emphasis-displaying a display portion in a higher-level hierarchy selected on the hierarchical menu screen or a display portion in a lower-level hierarchy selected on the hierarchical menu screen, the lower-level hierarchy being derived from an item in the higher-level hierarchy;
identifiably displaying the item in the higher-level hierarchy, when the display portion in the selected lower-level hierarchy is emphasis-displayed;
identifiably displaying an executable item in the lower-level hierarchy, when the display portion in the selected higher-level hierarchy is emphasis-displayed;
emphasis-displaying the display portion in the lower-level hierarchy as a result of a selection of an item of the white balance adjustment processing in the higher-level hierarchy and allowing the white balance adjustment processing to be executed or canceled in the lower-level hierarchy on the hierarchical menu screen; and
displaying on the monitor the image on which the white balance adjustment processing was executed or for which the white balance adjustment was canceled in the lower-level hierarchy.

25. A method of displaying a picked-up image of an object and nondestructively testing the object: comprising:
obtaining the picked-up image of the object and displaying the image on a monitor;
displaying a hierarchical menu screen for performing a formatting processing of a storage medium for recording the image on the monitor, the hierarchical menu screen including at least three hierarchies;
emphasis-displaying a display portion in a hierarchy selected on the hierarchical menu screen compared with a display portion in a higher-level hierarchy than the selected hierarchy and a display portion in a lower-level hierarchy than the selected hierarchy, the selected hierarchy being derived from an item in the higher-level hierarchy;
identifiably displaying the item in the higher-level hierarchy, when the display portion in the selected hierarchy is emphasis-displayed;
identifiably displaying an executable item in the lower-level hierarchy, when the display portion in the selected hierarchy is emphasis-displayed, the lower-level hierarchy being derived from an item in the selected hierarchy;
emphasis-displaying the display portion in the lower-level hierarchy as a result of a selection of an item of the formatting processing and allowing the formatting processing to be executed or canceled in the lower-level hierarchy on the hierarchical menu screen; and
displaying the image on the monitor after the formatting processing performed in the lower-level hierarchy.

26. A method of displaying a picked-up image of an object and nondestructively testing the object: comprising:
obtaining the picked-up image of the object and displaying the image on a monitor;
displaying a hierarchical menu screen for setting a recording mode for recording the image in a storage medium on the monitor, the hierarchical menu screen including at least three hierarchies;
emphasis-displaying a display portion in a hierarchy selected on the hierarchical menu screen compared with a display portion in a higher-level hierarchy than the selected hierarchy and a display portion in a lower-level hierarchy than the selected hierarchy, the selected hierarchy being derived from an item in the higher-level hierarchy;
identifiably displaying the item in the higher-level hierarchy, when the display portion in the selected hierarchy is emphasis-displayed;
identifiably displaying an executable item in the lower-level hierarchy, when the display portion in the selected hierarchy is emphasis-displayed, the lower-level hierarchy being derived from an item in the selected hierarchy;
emphasis-displaying the display portion in the lower-level hierarchy as a result of a selection of an item of the recording mode setting and allowing the recording mode to be selected in the lower-level hierarchy on the hierarchical menu screen;
displaying the image on the monitor after the selection of the recording mode in the lower-level hierarchy; and
recording the image according to the selected recording mode after the selection of the recording mode in the lower-level hierarchy.

27. The method of nondestructively testing the object according to claim 26, wherein the recording mode includes a mode for recording only a still image and a mode for recording both of a still image and a moving image.
